(19) United States
(12) Patent Application Publication
(10) Pub. No.: US 2020/0293202 A1
(43) Pub. Date: Sep. 17, 2020

(54) APPARATUS AND METHOD OF AUTOMATIC CONFIGURATION OF STORAGE SPACE

(71) Applicant: SUPER MICRO COMPUTER, INC., SAN JOSE, CA (US)

(72) Inventor: HUNG-MING CHIEN, Hsinchu County (TW)

(21) Appl. No.: 16/354,809

(22) Filed: Mar. 15, 2019

(51) Int. Cl. G06F 3/06

(52) U.S. Cl. CPC G06F 3/0619; G06F 3/0673; G06F 3/0655

(57) ABSTRACT

An apparatus includes a control unit, a memory having computer program code, and a first storage unit. The first storage unit comprises a first consecutive storage region and a second consecutive storage region. The first storage unit stores a number M of categories of first data having a first attribute in the first consecutive storage region and a number N of first error correction data in the second consecutive storage region. The number N of first error correction data stored in the second consecutive storage region of the first storage unit are independent of the number M of categories of first data stored in the first consecutive storage region of the first storage unit.

### TECHNICAL FIELD

The subject application generally relates to storage space management, and specifically relates to an apparatus and method of automatic configuration of storage space.

### BACKGROUND

Some solutions were developed to provide a safe data storage. However, as technology progresses, security of data or files (or backup of data) becomes a critical issue.

### SUMMARY

A data allocation mechanism is proposed. In some of the storage units, a consecutive storage region for storing client data and a distinct storage region for storing parity data are allocated. Furthermore, a spare region is allocated in each of the storage units to be used in the data reconstruction process. Each of the storage units may be assigned to a distinct client host (for example, a user, a host or a device external to the array of storage units). Even if the number of failed storage units exceeds a predetermined number, the data stored on each surviving storage unit can still be accessed by its respective client host. Also, the storage regions for storing parity data and the spare regions are disposed in each of the storage devices, and thus the workload will be balanced across all the storage units and no storage device will be idle.

In accordance with some embodiments of the subject application, an apparatus is disclosed. The apparatus includes a control unit, a memory having computer program code, and a first storage unit. The first storage unit includes a first consecutive storage region and a second consecutive storage region. The first storage unit stores a number M of groups of first data having a first attribute in the first consecutive storage region and a number N of first error correction data in the second consecutive storage region. The number N of first error correction data stored in the second consecutive storage region of the first storage unit are independent of the number M of groups of first data stored in the first consecutive storage region of the first storage unit.

An apparatus in accordance with some embodiments of the subject application is disclosed. The apparatus includes a first storage unit having a first consecutive storage region and a second consecutive storage region. The first storage unit stores a number M of groups of first data having a first attribute in the first consecutive storage region. The first storage unit stores a number N of first error correction data in the second consecutive storage region. The number N of first error correction data stored in the second consecutive storage region of the first storage unit are independent of the number M of groups of first data stored in the first consecutive storage region of the first storage unit.

In accordance with some embodiments of the subject application, a method for managing data in a storage system having N storage units is disclosed. Each of the N storage units includes a first consecutive storage region and a second consecutive storage region. The method comprises storing a group of first data including M segments in the first consecutive storage region of a i^{th} storage unit to a (i+M−1)_{N}^{th} storage unit. The method comprises storing a first error correction data associated with the group of first data in the second consecutive storage region of a (i+M−1+k₁)_{N}^{th} storage unit. The method comprises storing a group of second data including M segments in the first consecutive storage region of the i^{th} storage unit to the (1+M−1)_{N}^{th} storage unit. The method comprises storing a second error correction data associated with the group of second data in the second consecutive storage region of a (i+M−1+k₂)_{N}^{th} storage unit. Wherein (i+M−1)_{N} is defined as (i+M−1) mod N. Wherein (i+M−1+k₁)_{N} and (i+M−1+k₂)_{N} are not in the range of i to (i+M−1)_{N}. Wherein k₁ and k₂ are different positive integers. Wherein N is greater than M.

### BRIEF DESCRIPTION OF THE DRAWINGS

Aspects of the subject application are readily understood from the following detailed description when read with the accompanying figures. It is noted that various features may not be drawn to scale, and the dimensions of the various features may be arbitrarily increased or reduced for clarity of discussion

FIG. 1 is a schematic diagram illustrating an apparatus according to some embodiments of the subject application.

FIG. 2 is a schematic diagram illustrating a storage space configuration according to some embodiments of the subject application.

FIG. 3 is a schematic diagram illustrating data structure in a storage system according to some embodiments of the subject application.

FIG. 3A, FIG. 3B and FIG. 3C are schematic diagrams of data allocation at various stages to form the data structure as shown in FIG. 3 according to some embodiments of the subject application.

FIG. 4 is a schematic diagram illustrating a storage space configuration according to some embodiments of the subject application.

FIG. 5 is a schematic diagram illustrating data structure in a storage system according to some embodiments of the subject application.

FIG. 5A, FIG. 5B and FIG. 5C are schematic diagrams of data allocation at various stages to form the data structure as shown in FIG. 5 according to some embodiments of the subject application.

FIG. 6A is a schematic diagram illustrating data structure in a storage system according to some embodiments of the subject application.

FIG. 6B is a schematic diagram illustrating data structure in a storage system according to some embodiments of the subject application.

FIG. 7 is a schematic diagram illustrating another apparatus according to some embodiments of the subject application.

FIG. 8 is a schematic diagram illustrating a storage space configuration according to some comparative embodiments of the subject application.

FIG. 9 is a schematic diagram illustrating another storage space configuration according to some comparative embodiments of the subject application.

FIG. 10 is a flow chart illustrating operations for storing data in a file system according to some embodiments of the subject application.

### DETAILED DESCRIPTION

Embodiments of the subject application and use thereof are discussed in detail below. It should be appreciated, however, that the embodiments set forth many applicable concepts that can be embodied in a wide variety of specific contexts. It is to be understood that the following disclosure provides for many different embodiments or examples of implementing different features of various embodiments. Specific examples of components and arrangements are described below for purposes of discussion. These are, of course, merely examples and are not intended to be limiting.

Spatial descriptions, including such terms as “above,” “below,” “up,” “left,” “right,” “down,” “top,” “bottom,” “vertical,” “horizontal,” “side,” “higher,” “lower,” “upper,” “over,” “under,” and so forth, are used herein with respect to an orientation shown in corresponding figures unless otherwise specified. It should be understood that the spatial descriptions used herein are for purposes of illustration, and that practical implementations of the structures described herein can be spatially arranged in any orientation or manner, provided that the merits of embodiments of this disclosure are not deviated from by such arrangement.

Embodiments, or examples, illustrated in the figures are disclosed below using specific language. It will nevertheless be understood that the embodiments and examples are not intended to be limiting. Any alterations and modifications of the disclosed embodiments, and any further applications of the principles disclosed in this document, as would normally occur to one of ordinary skill in the pertinent art, fall within the scope of this disclosure.

In addition, the subject application may repeat reference numerals and/or letters in the various examples. This repetition is for the purpose of simplicity and clarity and does not in itself dictate a relationship between the various embodiments and/or configurations discussed herein.

Some solutions were developed to secure data storage, which make different tradeoffs between storage capability (e. g., size of storage space), data processing capacity (e.g. data access speed), cost, fault tolerance (e.g., error correction or data recovery), etc.

Certain error correction techniques were developed to enhance fault tolerance. However, once a number of failed storage units exceeds a threshold, some data segments stored in the failed storage units cannot be recovered, which jeopardizes data integrity.

As technology advances, a single storage unit (for example but is not limited to, a hard disk or other type of memories) may have a storage capacity up to 100 terabytes (TP) or more. Failure of multiple storage units may cause data loss on a petabytes (PB) scale, and such significant data loss is not tolerable. Therefore, there is a need to develop a new technique to deal with the above-mentioned issues.

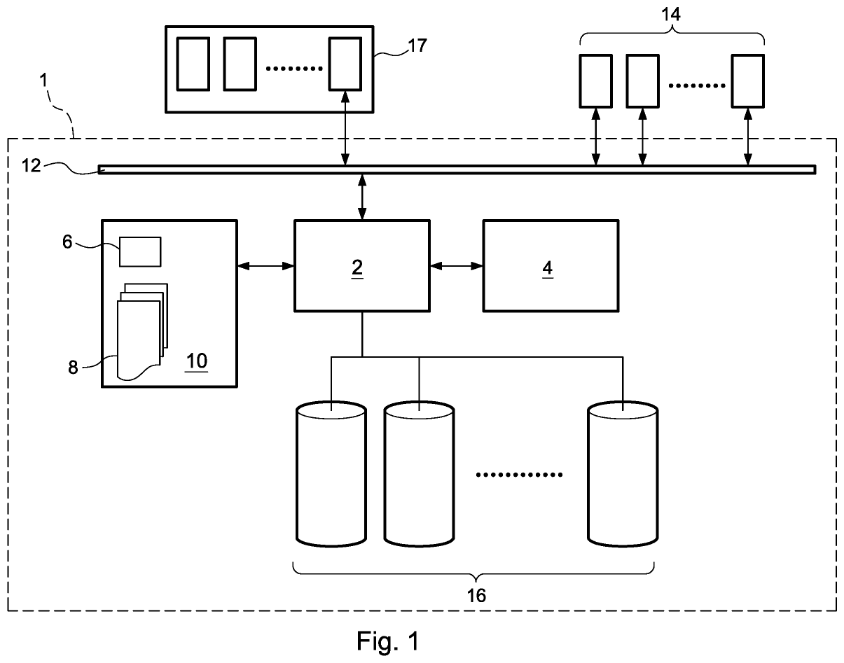

FIG. 1 is a schematic diagram illustrating an apparatus according to some embodiments of the subject application.

Referring to FIG. 1, an apparatus 1 includes a control unit 2, an acceleration unit 4, a memory unit 10, a transceiving unit 12 and a storage system 16. The apparatus 1 may include a server, a data center, a data storage apparatus or the like.

A number of external devices or client hosts 14 are electrically connected to the apparatus 1 through either a wired or wireless communication interface (not illustrated in FIG. 1). A storage system 17, which includes multiple storage units, are electrically connected to the apparatus 1 through either a wired or wireless communication interface (not illustrated in FIG. 1).

The memory unit 10 includes a cache 6. The memory unit 10 includes a set of lookup tables 8. The memory 10 may include computer program code stored therein (not illustrated in FIG. 1). The memory unit 10 and the computer program code are configured to, with the control unit 12, cause the apparatus 1 to perform several operations that will be described in the paragraphs below.

The control unit 2 may include but is not limited to, for example, a central processing unit (CPU), a microprocessor, an application-specific instruction set processor (ASIP), a machine control unit (MCU), a graphics processing unit (GPU), a physics processing unit (PPU), a digital signal processor (DSP), an image processor, a coprocessor, a storage controller, a floating-point unit, a network processor, a multi-core processor, a front-end processor or the like. The control unit 2 is electrically connected to the memory unit 10. The control unit 2 is electrically connected to the acceleration unit 4. The control unit 2 is electrically connected to the transceiving unit 12. The control unit 2 is electrically connected to the storage system 16.

The acceleration unit 4 may include but is not limited to, for example, a microprocessor, a coprocessor, an application-specific instruction set processor (ASIP), a physics processing unit (PPU), a digital signal processor (DSP), a synergistic processing element or the like. The acceleration unit 4 is able to supplement the functions of the control unit 2. Operation performed by the acceleration unit 4 may include but is not limited to, for example, floating point arithmetic, graphics, signal processing, string processing, cryptography or I/O interfacing with peripheral devices. Performance of apparatus 1 may be accelerated with the help of the acceleration unit 4, which shares some tasks with the control unit 2.

The memory unit 10 may include but is not limited to a random-access memory (RAM) such as a static RAM (SRAM) or a dynamic RAM (DRAM). In some embodiments, the memory unit 10 may include a read-only memory (ROM). The memory unit 10 includes a cache 6 for storing data that have recently been accessed, so that future requests for that data can be served faster. The data stored in the cache 6 may include the result of an earlier computation of the control unit 2 or the acceleration unit 4. The data stored in the cache 6 may include a copy of data stored in one of the storage units 16.

The memory unit 10 includes a set of lookup tables 8. A lookup table 8 may include addresses of storage unit in the storage system 16 to be assigned to data. A lookup table 8 may include data attributes. A lookup table 8 may include categorization associated with data attributes. A lookup table 8 may include addresses of storage unit in the storage system 16 to be assigned to error correction data. A lookup table 8 may include addresses of storage unit in the storage system 16 to be assigned to reconstruction data. It is contemplated that the lookup tables 8 may be integrated into one single lookup table.

The apparatus 1 can access the storage system 16 based on the lookup table(s) 8. Based on the lookup table(s) 8, the apparatus 1 may reconstruct or rebuild data in the storage system 16. Based on the lookup table(s) 8, the apparatus 1 may store the reconstructed or rebuilt data in a spare region or space in the storage system 16.

The control unit 2 may be configured to create or generate lookup table(s) 8 and store them in the memory unit 10. The control unit 2 is configured to update the lookup table(s) 8 for a new or different data arrangement, deployment or allocation scheme in the storage system 16. The control unit 2 is configured to create or generate the lookup table(s) 8 and store them in the storage system 16. The control unit 2 is configured to read the lookup table(s) 8 from the storage system 16 and write them in the memory unit 10.

The transceiving unit 12 involves communications between the apparatus 1 and the external devices 14. The transceiving unit 12 involves communications between the apparatus 1 and the storage system 17. The transceiving unit 12 may include hardware component(s), software implementation compatible with an interface or communication protocol including but not limited to, for example, Ethernet, fibre channel over Ethernet (FCoE), peripheral component interconnect express (PCIe), advanced host controller interface (AHCI), Bluetooth, WiFi and cellular data service such as GSM, CDMA, GPRS, WCDMA, EDGE, CDMA2000 or LTE, or a combination of the above. An electrical connection exists between the control unit 2 and the transceiving unit 12. The electrical connection between the control unit 2 and the transceiving unit 12 may include but is not limited to a high speed I/O connection.

The storage system 16 includes multiple storage units. The storage unit of the storage system 16 may include but is not limited to, for example, a hard disk drive (HDD), a solid-state drive (SSD), an embedded multimedia card (eMMC), a secure digital (SD) memory card, or other type of storage device. The storage units of the storage system 16 may be arranged in an array and electrically connected to the control unit 2. In some embodiment, the lookup tables 8 may be stored in one of the storage units 16 and the control unit 2 can determine when to read them and put them into the memory unit 10.

The storage system 17 is similar to the storage system 16. The storage system 17 may function as a local data backup for the storage system 16. The storage system 17 may function as a cloud backup or online backup for the storage system 16.

The client host 14 may include an electronic device, for example but is not limited to, personal computer, laptop, server, mobile phone, tablet, Internet of things (IoT) device, or the like.

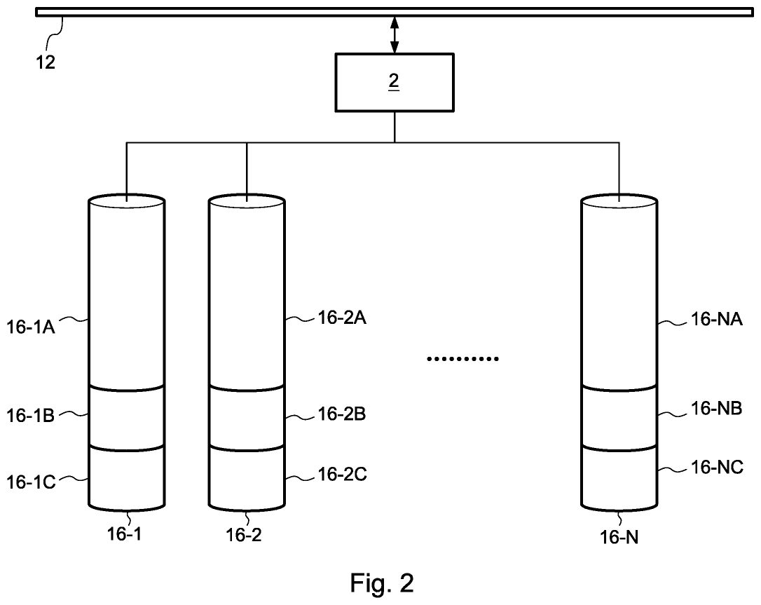

FIG. 2 is a schematic diagram illustrating a storage space configuration according to some embodiments of the subject application.

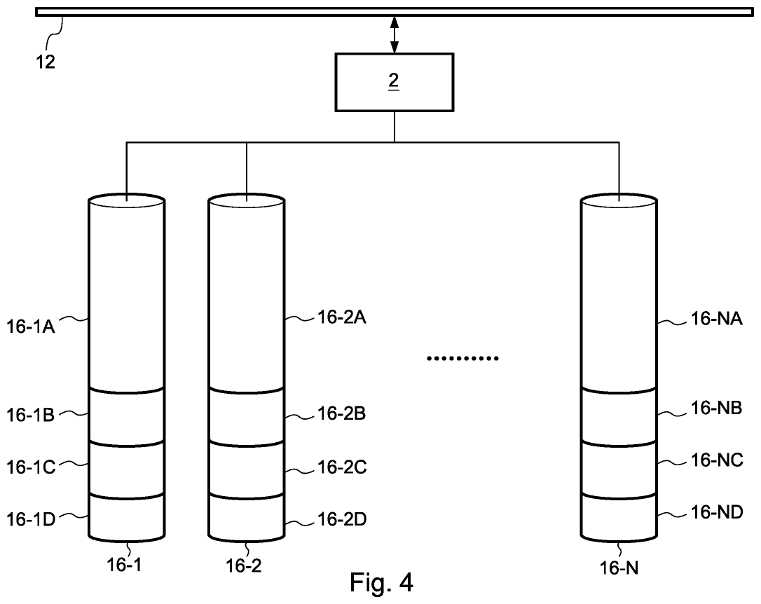

For simplicity, the control unit 2, the transceiving unit 12 and some storage units 16-1, 16-2, . . . , and 16-N in the storage system 16 of the apparatus 1 are illustrated in FIG. 4, wherein N is a positive integer.

Referring to FIG. 2, the storage unit 16-1 is configured to include a consecutive storage region 16-1A, another consecutive storage region 16-1B, and another consecutive storage region 16-1C.

The consecutive storage region 16-1A may include a series of physically or logically consecutive addresses. The consecutive storage region 16-1B may include a series of physically or logically consecutive addresses. The consecutive storage region 16-1C may include a series of physically or logically consecutive addresses. The consecutive storage region 16-1B is next to the consecutive storage region 16-1A. The consecutive storage region 16-1C is next to the consecutive storage region 16-1B.

For example, the consecutive storage region 16-1A may include a series of logically consecutive addresses [XX0001], [XX0002], [XX0003], [XX0004], [XX0005], [XX0006] in the storage unit 16-1. The consecutive storage region 16-1B may include a series of logically consecutive addresses [YY0001], [YY0002], [YY0003] in the storage unit 16-1. The consecutive storage region 16-1C may include a series of logically consecutive addresses [ZZ0001], [ZZ0002], [ZZ0003] in the storage unit 16-1. The consecutive storage regions 16-1A, 16-1B and 16-1C are classified as distinct partitions for storing data. In some embodiments, the consecutive storage regions 16-1A, 16-1B and 16-1C may be adjacent to each other. In some embodiments, the consecutive storage regions 16-1A, 16-1B and 16-1C are not adjacent area to each other.

In some embodiments, the consecutive storage region 16-1A may include a series of physically consecutive sectors 1, 2, 3, 4, 5, 6 on a track 1 in the storage unit 16-1. The consecutive storage region 16-1B may include a series of physically consecutive sectors 7, 8, 9 on the track 1 in the storage unit 16-1. The consecutive storage region 16-1C may include physically consecutive sectors 10, 11, 12 on the track 1 in the storage unit 16-1.

In some embodiments, the consecutive storage regions 16-1A and 16-1B are configured to have an end-to-end arrangement. The consecutive storage regions 16-1B and 16-1C are configured to have an end-to-end arrangement. It is contemplated that any two of the consecutive storage regions 16-1A, 16-1B and 16-1C may be swapped.

Each of the storage units 16-2 to 16-N may has a storage configuration same or similar to the storage unit 16-1. It is contemplated that each of the storage units 16-1, 16-2, . . . , and 16-N may be configured to have more or less consecutive storage regions.

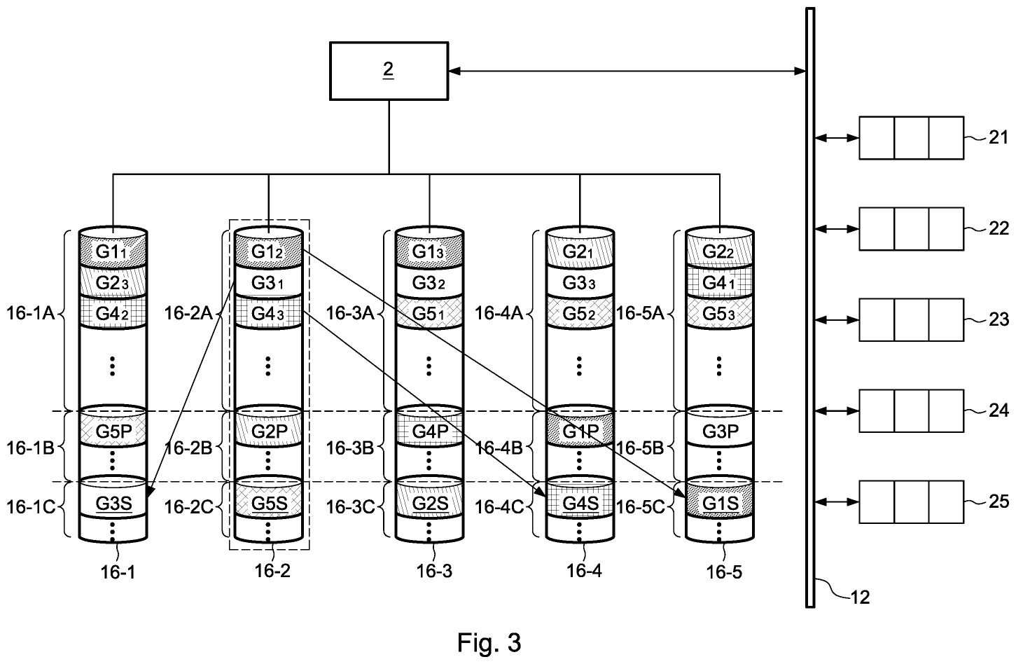

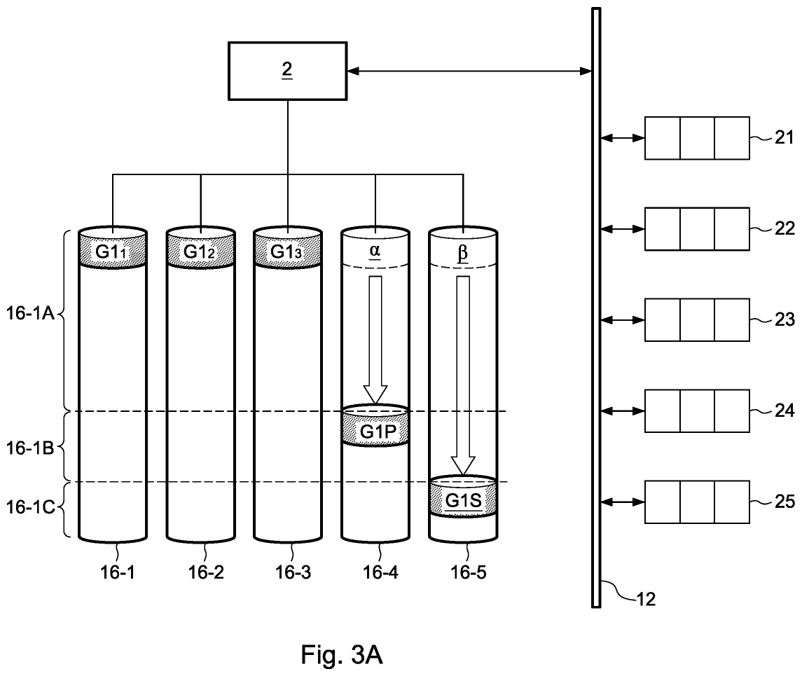

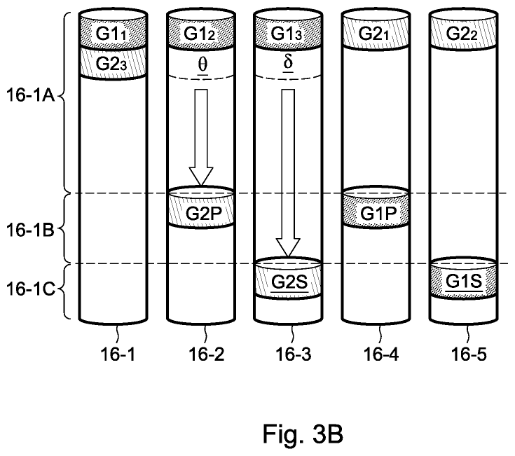

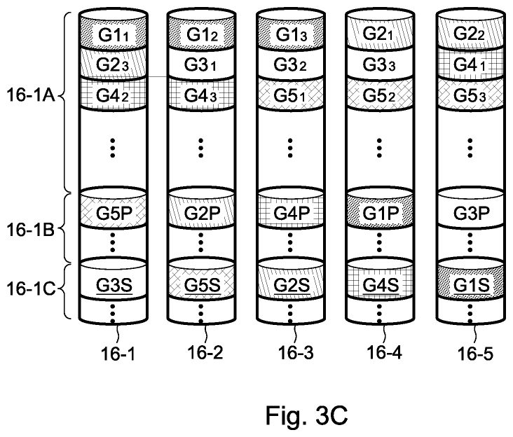

FIG. 3 is a schematic diagram illustrating data structure in a storage system according to some embodiments of the subject application.

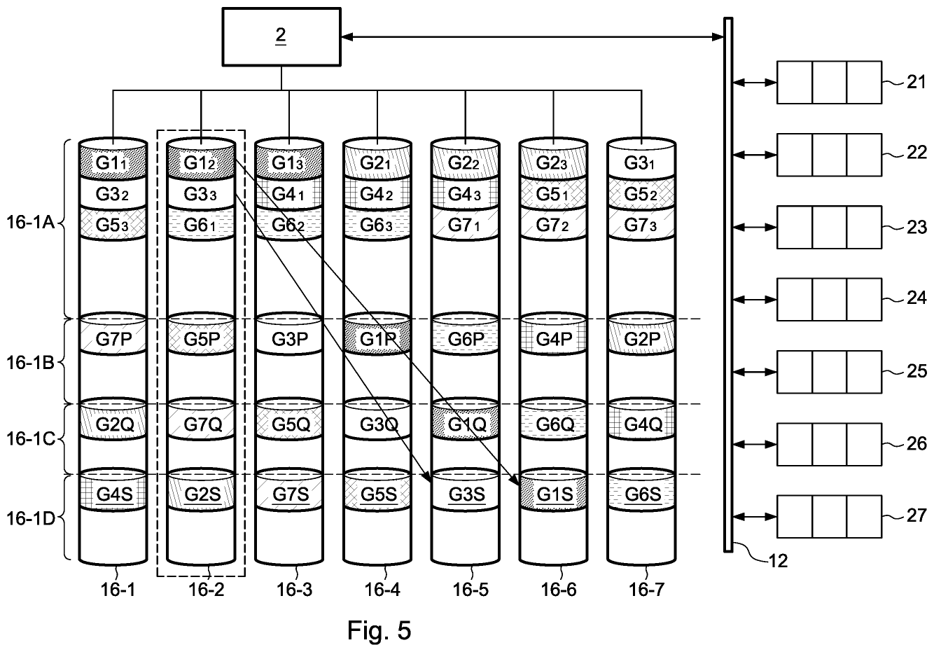

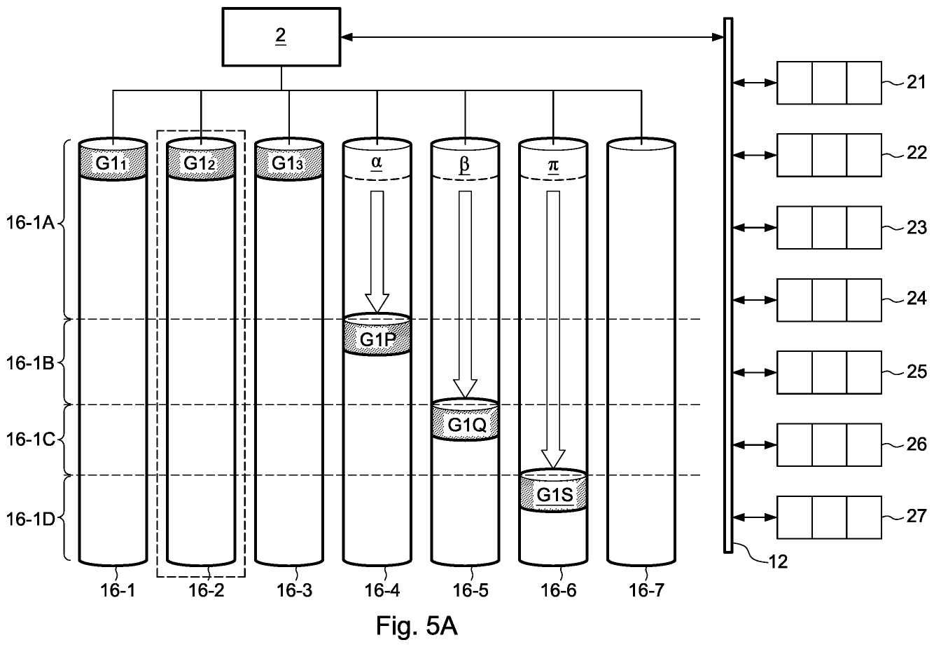

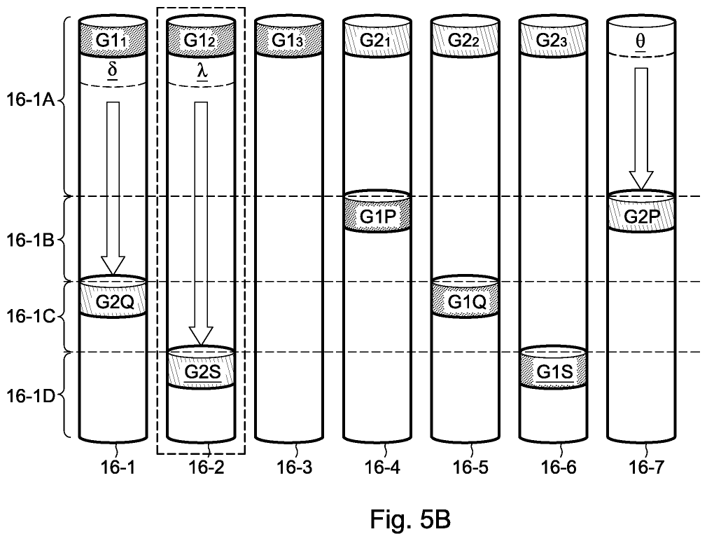

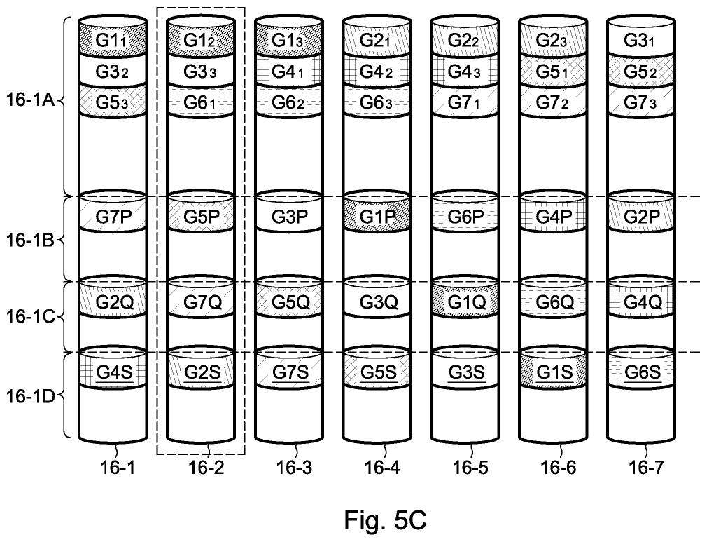

For simplicity, the control unit 2, the transceiving unit 12 and some storage units 16-1, 16-2, 16-3, 16-4 and 16-5 in the storage system 16 of the apparatus 1 are illustrated in FIG. 5.

Referring to FIG. 3, the control unit 2 receives data 21, 22, 23, 24 and 25 through the help of the transceiving unit 12. Each of the data 21, 22, 23, 24 and 25 may be received from a unique client host 14. Each of the data 21, 22, 23, 24 and 25 may be received from multiple client hosts 14. Each of the data 21, 22, 23, 24 and 25 is an object with data integrity, include but not limited to, a file, a directory, a complete file system, a data base, an user profile, or an object storage unit.

Each of the data 21, 22, 23, 24 and 25 may include attribute associated with a unique client host 14. Each of the data 21, 22, 23, 24 and 25 may include attribute associated with a user account. Each of the data 21, 22, 23, 24 and 25 may include attribute associated with a unique internet protocol (IP) address. Each of the data 21, 22, 23, 24 and 25 may include attribute(s) other than the attributes as discussed above.

The control unit 2 may store the data 21, 22, 23, 24 and 25 in accordance with the lookup table(s) 8 as shown in FIG. 1. The control unit 2 stores the data 21 in the storage unit 16-1. The control unit 2 stores the data 22 in the storage unit 16-2. The control unit 2 stores the data 23 in the storage unit 16-3. The control unit 2 stores the data 24 in the storage unit 16-4. The control unit 2 stores the data 25 in the storage unit 16-5.

The control unit 2 stores the data 21 in the consecutive storage region 16-1A. The control unit 2 stores the data 22 in the consecutive storage region 16-2A. The control unit 2 stores the data 23 in the consecutive storage region 16-3A. The control unit 2 stores the data 24 in the consecutive storage region 16-4A. The control unit 2 stores the data 25 in the consecutive storage region 16-5A.

The data 21 may be divided into segments and then stored in the consecutive storage region 16-1A. The data 22 may be divided into segments and then stored in the consecutive storage region 16-2A. The data 23 may be divided into segments and then stored in the consecutive storage region 16-3A. The data 24 may be divided into segments and then stored in the consecutive storage region 16-4A. The data 25 may be divided into segments and then stored in the consecutive storage region 16-5A. Each of the data 21, 22, 23, 24 and 25 may be divided by, for example but is not limited to, data striping technique.

The segments of data 21 may be categorized and then stored in the consecutive storage region 16-1A. The segments of data 22 may be categorized and then stored in the consecutive storage region 16-2A. The segments of data 23 may be categorized and then stored in the consecutive storage region 16-3A. The segments of data 24 may be categorized and then stored in the consecutive storage region 16-4A. The segments of data 25 may be categorized and then stored in the consecutive storage region 16-5A.

For example, the data 21 may include categorized segments G1₁, G2₃, G4₂, . . . . For example, the data 22 may include categorized segments G1₂, G3₁, G4₃, . . . . For example, the data 23 may include categorized segments G1₃, G3₂, G5₁, . . . . For example, the data 24 may include categorized segments G2₁, G3₃, G5₂, . . . . For example, the data 25 may include categorized segments G2₂, G4₁, G5₃, . . . .

A group G1 of data includes the segments G1₁, G1₂, G1₃ . . . and error correction data G1P, . . . . A group G2 data includes the segments G2₁, G2₂, G2₃ . . . and error correction data G2P, . . . . A group G3 data includes the segments G3₁, G3₂, G3₃ . . . and error correction data G3P, . . . . A group G4 data includes the segments G4₁, G4₂, G4₃, . . . and error correction data G4P, . . . . A group G5 data includes the segments G5₁, G5₂, G5₃, . . . and error correction data G5P, . . . . In some embodiments, the segments of the same group are of the same size. For example, the segments G1₁, G1₂, G1₃ . . . , the error correction data G1P, and the spare region G1S are of the same size. In some embodiments, the segments of different groups are of different sizes.

As discussed with reference to FIG. 1, the lookup table(s) 8 may include location information of redundant data (for example, error correction data or parity data) for fault tolerance to secure data integrity.

The error correction data G5P, . . . are stored in the consecutive storage region 16-1B of the storage unit 16-1. The error correction data G2P, . . . are stored in the consecutive storage region 16-2B of the storage unit 16-2. The error correction data G4P, . . . are stored in the consecutive storage region 16-3B of the storage unit 16-3. The error correction data G1P, . . . are stored in the consecutive storage region 16-4B of the storage unit 16-4. The error correction data G3P, . . . are stored in the consecutive storage region 16-5B of the storage unit 16-5.

The error correction data G5P, . . . stored in the consecutive storage region 16-1B of the storage unit 16-1 are independent of the data segments G1₁, G2₃, G4₂, . . . stored in the consecutive storage region 16-1A of the storage unit 16-1. Any of the error correction data G5P, . . . stored in the consecutive storage region 16-1B of the storage unit 16-1 and the data segments G1₁, G2₃, G4₂, . . . stored in the consecutive storage region 16-1A of the storage unit 16-1 are categorized into different groups.

The error correction data G2P, . . . stored in the consecutive storage region 16-2B of the storage unit 16-2 are independent of data segments G1₂, G3₁, G4₃, . . . stored in the consecutive storage region 16-2A of the storage unit 16-2. Any of the error correction data G2P, . . . stored in the consecutive storage region 16-2B of the storage unit 16-2 and the data segments G1₂, G3₁, G4₃, . . . stored in the consecutive storage region 16-2A of the storage unit 16-2 are categorized into different groups.

The error correction data G4P, . . . stored in the consecutive storage region 16-3B of the storage unit 16-3 are independent of the data segments G1₃, G3₂, G5₁, . . . stored in the consecutive storage region 16-3A of the storage unit 16-3. Any of the error correction data G4P, . . . stored in the consecutive storage region 16-3B of the storage unit 16-3 and the data segments G1₃, G3₂, G5₁, . . . stored in the consecutive storage region 16-3A of the storage unit 16-3 are categorized into different groups.

The error correction data G1P, . . . stored in the consecutive storage region 16-4B of the storage unit 16-4 are independent of data segments G2₁, G3₃, G5₂, . . . stored in the consecutive storage region 16-4A of the storage unit 16-4. Any of the error correction data G1P, . . . stored in the consecutive storage region 16-4B of the storage unit 16-4 and the data segments G2₁, G3₃, G5₂, . . . stored in the consecutive storage region 16-4A of the storage unit 16-4 are categorized into different groups.

The error correction data G3P, . . . stored in the consecutive storage region 16-5B of the storage unit 16-5 are independent of data segments G2₂, G4₁, G5₃, . . . stored in the consecutive storage region 16-5A of the storage unit 16-5. Any of the error correction data G3P, . . . stored in the consecutive storage region 16-5B of the storage unit 16-5 and the data segments G2₂, G4₁, G5₃, . . . stored in the consecutive storage region 16-5A of the storage unit 16-5 are categorized into different groups.

If one of the storage units 16-1, 16-2, 16-3, 16-4 and 16-5 (e.g., the storage unit 16-2) fails, or the segment G1₂ is damaged, the control unit 2 may rebuild or reconstruct the segment G1₂ by the segments G1₁ and G1₃ and the error correction data G1P. The control unit 2 may store the rebuilt or reconstructed segment G1₂ in the region G1S in the consecutive region 16-5C of the storage unit 16-5.

If one of the storage units 16-1, 16-2, 16-3, 16-4 and 16-5 (e.g., the storage unit 16-2) fails, or the segment G3₁ is damaged, the control unit 2 may rebuild or reconstruct the segment G3₁ by the segments G3₂ and G3₃ and the error correction data G3P. The control unit 2 may store the rebuilt or reconstructed segment G3₁ in the region G3S in the consecutive region 16-1C of the storage unit 16-1.

If one of the storage units 16-1, 16-2, 16-3, 16-4 and 16-5 (e.g., the storage unit 16-2) fails, or the segment G4₃ is damaged, the control unit 2 may rebuild or reconstruct the segment G4₃ by the segments G4₁ and G4₂ and the error correction data G4P. The control unit 2 may store the rebuilt or reconstructed segment G4₃ in the region G4S in the consecutive region 16-4C of the storage unit 16-4.

Although the loss of data segments may not be recovered due to relatively more failed storage units or relatively more segment losses, the data structure shown in FIG. 3 may help each of the surviving storage units secure data integrity for its unique client or client host.

FIG. 3A, FIG. 3B and FIG. 3C are schematic diagrams of data allocation at various stages to form the data structure as shown in FIG. 3 according to some embodiments of the subject application.

For simplicity, the control unit 2, the transceiving unit 12 and some storage units 16-1, 16-2, 16-3, 16-4 and 16-5 in the storage system 16 of the apparatus 1 are illustrated in FIG. 3A.

Referring to FIG. 3A, the control unit 2 receives data 21, 23, 24 and 25 through the help of the transceiving unit 12. Each of the data 21, 23, 24 and 25 may be received from a unique client host 14. Each of the data 21, 22, 23, 24 and 25 may be received from multiple client hosts 14. Each of the data 21, 22, 23, 24 and 25 is an object with data integrity, include but not limited to, a file, a directory, a complete file system, a data base, an user profile, or an object storage unit.

Each of the data 21, 22, 23, 24 and 25 may include attribute associated with a unique client host 14. Each of the data 21, 22, 23, 24 and 25 may include attribute associated with a user account. Each of the data 21, 22, 23, 24 and 25 may include attribute associated with a unique internet protocol (IP) address. Each of the data 21, 22, 23, 24 and 25 may include attribute(s) other than the attributes as discussed above.

Prior to data allocation, the data 21 may be segmented and categorized to form the categorized segments G1₁, G2₃, G4₂, . . . . Prior to data allocation, the data 22 may be segmented and categorized to form the G1₂, G3₁, G4₃, . . . . Prior to data allocation, the data 23 may be segmented and categorized to form the categorized segments G1₃, G3₂, G5₁, . . . . Prior to data allocation, the data 24 may be segmented and categorized to form the categorized segments G2₁, G3₃, G5₂, . . . . Prior to data allocation, the data 25 may be segmented and categorized to form the categorized segments G2₂, G4₁, G5₃, . . . .

Prior to data allocation, the segments G1₁, G1₂, G1₃ and error correction data G1P are assigned to a group G1. Prior to data allocation, the segments G2₁, G2₂, G2₃ and error correction data G2P are assigned to a group G2. Prior to data allocation, the segments G3₁, G3₂, G3₃ and error correction data G3P are assigned to a group G3. Prior to data allocation, the segments G4₁, G4₂, G4₃, and error correction data G4P are assigned to a group G4. Prior to data allocation, the segments G5₁, G5₂, G5₃, and error correction data G5P are assigned to a group G5.

Data allocation of group G1 is shown in FIG. 3A. The data segment G1₁ is stored in the consecutive storage region 16-1A of the storage unit 16-1. The data segment G1₂ is stored in the consecutive storage region 16-2A of the storage unit 16-2. The data segment G1₃ is stored in the consecutive storage region 16-3A of the storage unit 16-3. The space for storing data segment G1₁ physically or logically corresponds to the space for storing data segment G1₂. The space for storing data segment G1₂ physically or logically corresponds to the space for storing data segment G1₃.

The error correction data G1P, instead of being stored in a space α which physically or logically corresponds to the space for storing data segment G1₁, G1₂ or G1₃, is stored in the consecutive storage region 16-4B of the storage unit 16-4. The space α is in the consecutive storage region 16-4A of the storage unit 16-4. The space α is configured to store data segment of another group (e.g., group G2).

The error correction data G1P associated with the group G1 is stored in a storage unit different from those for storing data segments G1₁, G1₂, . . . , and G1₃. The error correction data G1P associated with the group G1 is stored in a storage unit next to that for storing the last data segment of the group G1 (e.g., the segment G1₃).

A space G1S in the consecutive storage region 16-5C of the storage unit 16-5 is configured or reserved to store reconstructed, rebuilt, or recovered segment of the group G1. In other words, the space G1S may function as a spare region to store reconstructed, rebuilt, or recovered segment of the group G1. The spare region G1S associated with the group G1 is allocated in a storage unit different from those for storing data segments G1₁, G1₂, . . . , and G1₃ and the error correction data G1P. The spare region G1S associated with the group G1 is allocated in a storage unit next to that for storing the error correction data G1P.

A space β in the consecutive storage region 16-5A of the storage unit 16-5, which physically or logically corresponds to the space α, is configured to store data segment of another group (e.g., group G2).

The allocation of the segments G1₁, G1₂, G1₃, the error correction data G1P and the spare region G1S may be performed at the same time. The allocation of the segments G1₁, G1₂, G1₃, the error correction data G1P and the spare region G1S may be performed in sequence

Referring to FIG. 3B, for simplicity, only the storage units 16-1, 16-2, 16-3, 16-4 and 16-5 are illustrated.

Data allocation of group G2 is shown in FIG. 3B. The data segment G2₁ is stored in the space α in the consecutive storage region 16-4A of the storage unit 16-4. The data segment G2₂ is stored in the space β in the consecutive storage region 16-5A of the storage unit 16-5. The data segment G2₃ is stored in the consecutive storage region 16-1A of the storage unit 16-1. The data segment G2₃ is stored adjacent or next to the data segment G1₁.

The error correction data G2P, instead of being stored in a space θ which physically or logically corresponds to the space for storing data segment G2₃, is stored in the consecutive storage region 16-2B of the storage unit 16-2. The space θ is in the consecutive storage region 16-2A of the storage unit 16-2. The space θ is configured to store data segment of another group (e.g., group G3). The error correction data G2P associated with the group G2 is stored in a storage unit different from those for storing data segments G2₁, G2₂, and G2₃. The error correction data G2P associated with the group G2 is stored in a storage unit next to that for storing the last data segment of the group G2 (e.g., the segment G2₃).

A space G2S in the consecutive storage region 16-3C of the storage unit 16-3 is configured or reserved to store reconstructed, rebuilt, or recovered segment of the group G2. In other words, the space G2S may function as a spare region to store reconstructed, rebuilt, or recovered segment of the group G2. A space δ in the consecutive storage region 16-3A of the storage unit 16-3, which physically or logically corresponds to the space θ, is configured to store data segment of another group (e.g., group G3). The spare region G2S associated with the group G2 is allocated in a storage unit different from those for storing data segments G2₁, G2₂, and G2₃ and the error correction data G2P. The spare region G2S associated with the group G2 is allocated in a storage unit next to that for storing the error correction data G2P.

The allocation of the segments G2₁, G2₂, G2₃, the error correction data G2P and the spare region G2S may be performed at the same time. The allocation of the segments G2₁, G2₂, G2₃, the error correction data G2P and the spare region G2S may be performed in sequence.

Referring to FIG. 3C, for simplicity, only the storage units 16-1, 16-2, 16-3, 16-4 and 16-5 are illustrated. Data allocation of groups G3, G4 and G5 is shown in FIG. 3C.

The data segment G3₁ of data 22 is stored in the consecutive storage region 16-2A of the storage unit 16-2. The data segment G3₂ of data 23 is stored in the consecutive storage region 16-3A of the storage unit 16-3. The data segment G3₃ of data 24 is stored in the consecutive storage region 16-4A of the storage unit 16-4.

Therefore, segments of data 21 (e.g., segments G1₁, G2₃, G4₂ . . . ) are stored in the consecutive storage region 16-1A of the storage unit 16-1; segments of data 22 (e.g., segments G1₂, G3₁, G4₃ . . . ) are stored in the consecutive storage region 16-2A of the storage unit 16-2; segments of data 23 (e.g., segments G1₃, G3₂, G5₁ . . . ) are stored in the consecutive storage region 16-3A of the storage unit 16-3; segments of data 24 (e.g., segments G2₁, G3₃, G5₂, . . . ) are stored in the consecutive storage region 16-4A of the storage unit 16-4; and segments of data 25 (e.g., segments G2₂, G4₁, G5₃, . . . ) are stored in the consecutive storage region 16-5A of the storage unit 16-5.

The error correction data (e.g., G3P) of a group (e.g., G3) is stored in a storage unit (e.g., 16-5) different from a storage unit (e.g., 16-2, 16-3 or 16-4) where the data segment (e.g., segment G3₁, G3₂ or G3₃) in the same group is stored. The error correction data (e.g., G4P) of a group (e.g., G4) is stored in a consecutive storage region (e.g., 16-3B) physically or logically different from a consecutive storage region (e.g., 16-5A, 16-1A or 16-2A) where the data segment in the same group (e.g., segment G4₁, G4₂ or G4₃) is stored.

A space (e.g., G5S) in a consecutive storage region (e.g., 16-2C) of a storage unit (e.g., 16-2) is configured or reserved to store reconstructed, rebuilt, or recovered segment of the same group (e.g., G5). A space (e.g., G4S) is configured in a storage unit (e.g., 16-4) different from a storage unit (e.g., 16-5, 16-1 or 16-2) where the data segment (e.g., segment G4₁, G4₂ or G4₃) in the same group is stored. A space (e.g., G4S) is configured in a storage unit (e.g., 16-4) different from a storage unit (e.g., 16-3) where the error correction data (e.g., segment G4P) in the same group is stored. A space (e.g., G3S) is configured in a consecutive storage region (e.g., 16-1C) physically or logically different from a consecutive storage region (e.g., 16-2A, 16-3A or 16-4A) where the data segment in the same group (e.g., segment G3₁, G3₂ or G3₃) is stored.

The allocation of data in different groups may be performed at the same time. The allocation of data in different groups may be performed in sequence. The allocation of data in different groups may be performed in numerical order.

The data segment, error correction data, and spare region of the following groups (e.g. groups G4, G5, G6 . . . ) are allocated, configured or stored by a rule or pattern analogous to the above.

In the embodiments as shown in FIG. 3, FIG. 3A, FIG. 3B or FIG. 3C, the number of storage units (e.g., 5) and the number of data segments in a group (e.g., 3) is co-prime (mutual-prime). However, the number of storage units and the number of data segments in a group may not be co-prime in accordance with some embodiments of the subject application.

FIG. 4 is a schematic diagram illustrating a storage space configuration according to some embodiments of the subject application.

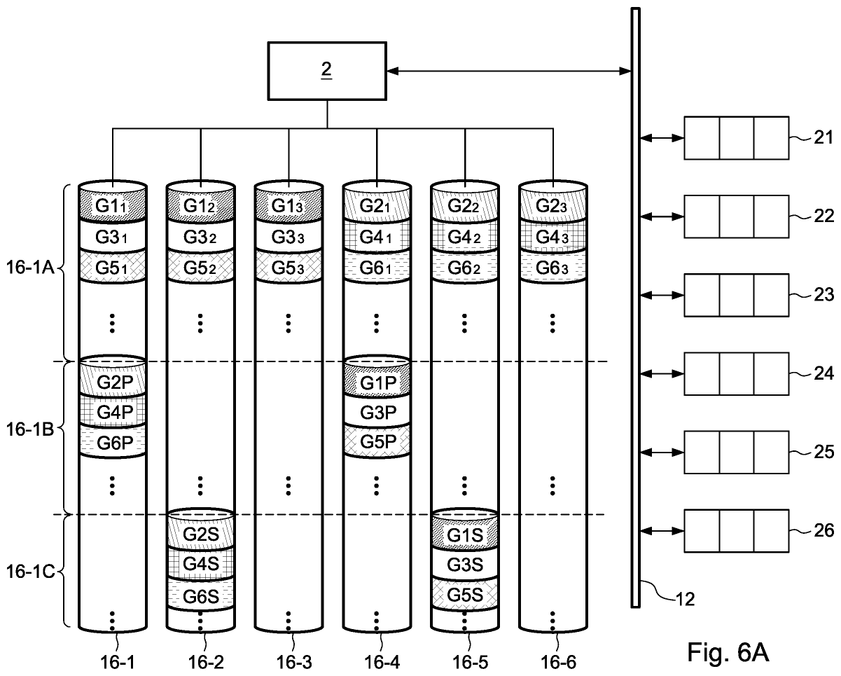

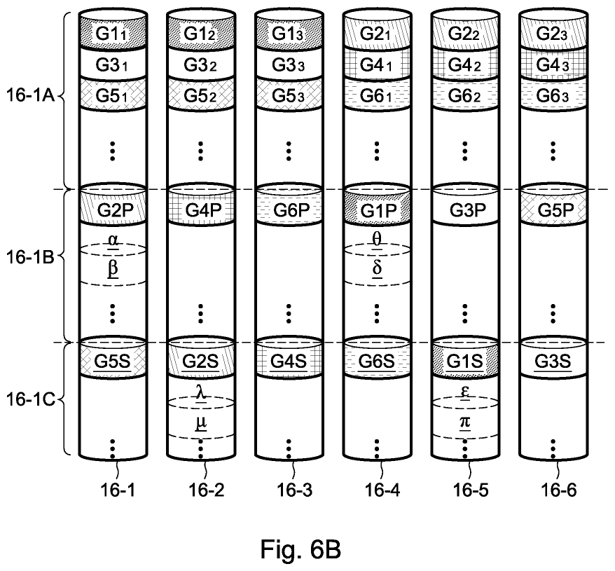

For simplicity, the control unit 2, the transceiving unit 12 and some storage units 16-1, 16-2, . . . , and 16-N in the storage system 16 of the apparatus 1 are illustrated in FIG. 6, wherein N is a positive integer.

Referring to FIG. 4, the storage unit 16-1 is configured to include a consecutive storage region 16-1A, another consecutive storage region 16-1B, another consecutive storage region 16-1C, and another consecutive storage region 16-1D.

The consecutive storage region 16-1A may include a series of physically or logically consecutive addresses. The consecutive storage region 16-1B may include a series of physically or logically consecutive addresses. The consecutive storage region 16-1C may include a series of physically or logically consecutive addresses. The consecutive storage region 16-1D may include a series of physically or logically consecutive addresses.

For example, the consecutive storage region 16-1A may include a series of logically consecutive addresses [XX0001], [XX0002], [XX0003], [XX0004], [XX0005], [XX0006] in the storage unit 16-1. The consecutive storage region 16-1B may include a series of logically consecutive addresses [YY0001], [YY0002], [YY0003] in the storage unit 16-1. The consecutive storage region 16-1C may include a series of logically consecutive addresses [ZZ0001], [ZZ0002], [ZZ0003] in the storage unit 16-1. The consecutive storage region 16-1D may include a series of logically consecutive addresses [WW0001], [WW0002], [WW0003] in the storage unit 16-1. The consecutive storage regions 16-1A, 16-1B, 16-1C and 16-1D are classified as distinct partitions for storing data. In some embodiments, the consecutive storage regions 16-1A, 16-1B, 16-1C and 16-1D may be adjacent to each other. In some embodiments, the consecutive storage regions 16-1A, 16-1B, 16-1C and 16-1D are not adjacent area to each other.

In some embodiments, the consecutive storage region 16-1A may include a series of physically consecutive sectors 1, 2, 3, 4, 5, 6 on a track 1 in the storage unit 16-1. The consecutive storage region 16-1B may include a series of physically consecutive sectors 7, 8, 9 on the track 1 in the storage unit 16-1. The consecutive storage region 16-1C may include physically consecutive sectors 10, 11, 12 on the track 1 in the storage unit 16-1. The consecutive storage region 16-1D may include physically consecutive sectors 13, 14, 15 on the track 1 in the storage unit 16-1.

In some embodiments, the consecutive storage regions 16-1A and 16-1B are configured to have an end-to-end arrangement. The consecutive storage regions 16-1B and 16-1C are configured to have an end-to-end arrangement. The consecutive storage regions 16-1C and 16-1D are configured to have an end-to-end arrangement. It is contemplated that any two of the consecutive storage regions 16-1A, 16-1B, 16-1C and 16-1D may be swapped.

Each of the storage units 16-2 to 16-N may has a storage configuration same or similar to the storage unit 16-1. It is contemplated that each of the storage units 16-1, 16-2, . . . , and 16-N may be configured to have more or less consecutive storage regions.

FIG. 5 is a schematic diagram illustrating data structure in a storage system according to some embodiments of the subject application.

For simplicity, the control unit 2, the transceiving unit 12 and some storage units 16-1, 16-2, 16-3, 16-4, 16-5, 16-6 and 16-7 in the storage system 16 of the apparatus 1 are illustrated in FIG. 5.

Referring to FIG. 5, the control unit 2 receives data 21, 22, 23, 24, 25, 26 and 27 through the help of the transceiving unit 12. Each of the data 21, 22, 23, 24, 25, 26 and 27 may be received from a unique client host 14. Each of the data 21, 22, 23, 24, 25, 26 and 27 may be received from multiple client hosts 14. Each of the data 21, 22, 23, 24, 25, 26 and 27 is an object with data integrity, include but not limited to, a file, a directory, a complete file system, a data base, an user profile, or an object storage unit.

Each of the data 21, 22, 23, 24, 25, 26 and 27 may include attribute associated with a unique client host 14. Each of the data 21, 22, 23, 24, 25, 26 and 27 may include attribute associated with a user account. Each of the data 21, 22, 23, 24, 25, 26 and 27 may include attribute associated with a unique internet protocol (IP) address. Each of the data 21, 22, 23, 24, 25, 26 and 27 may include attribute(s) other than the attributes as discussed above.

The control unit may store the data 21, 22, 23, 24, 25, 26 and 27 in accordance with the lookup table(s) 8 as shown in FIG. 1. The control unit 2 stores the data 21 in the storage unit 16-1. The control unit 2 stores the data 22 in the storage unit 16-2. The control unit 2 stores the data 23 in the storage unit 16-3. The control unit 2 stores the data 24 in the storage unit 16-4. The control unit 2 stores the data 25 in the storage unit 16-5. The control unit 2 stores the data 26 in the storage unit 16-6. The control unit 2 stores the data 27 in the storage unit 16-7.

The control unit 2 stores the data 21 in the consecutive storage region 16-1A. The control unit 2 stores the data 22 in the consecutive storage region 16-2A. The control unit 2 stores the data 23 in the consecutive storage region 16-3A. The control unit 2 stores the data 24 in the consecutive storage region 16-4A. The control unit 2 stores the data 25 in the consecutive storage region 16-5A. The control unit 2 stores the data 26 in the consecutive storage region 16-6A. The control unit 2 stores the data 27 in the consecutive storage region 16-7A.

The data 21 may be divided into segments and then stored in the consecutive storage region 16-1A. The data 22 may be divided into segments and then stored in the consecutive storage region 16-2A. The data 23 may be divided into segments and then stored in the consecutive storage region 16-3A. The data 24 may be divided into segments and then stored in the consecutive storage region 16-4A. The data 25 may be divided into segments and then stored in the consecutive storage region 16-5A. The data 26 may be divided into segments and then stored in the consecutive storage region 16-6A. The data 27 may be divided into segments and then stored in the consecutive storage region 16-7A. Each of the data 21, 22, 23, 24, 25, 26 and 27 may be divided by, for example but is not limited to, data striping technique.

The segments of data 21 may be categorized and then stored in the consecutive storage region 16-1A. The segments of data 22 may be categorized and then stored in the consecutive storage region 16-2A. The segments of data 23 may be categorized and then stored in the consecutive storage region 16-3A. The segments of data 24 may be categorized and then stored in the consecutive storage region 16-4A. The segments of data 25 may be categorized and then stored in the consecutive storage region 16-5A. The segments of data 26 may be categorized and then stored in the consecutive storage region 16-6A. The segments of data 27 may be categorized and then stored in the consecutive storage region 16-7A.

For example, the data 21 may include categorized segments G1₁, G3₂, G5₃, . . . . For example, the data 22 may include categorized segments G1₂, G3₃, G6₁, . . . . For example, the data 23 may include categorized segments G1₃, G4₁, G6₂, . . . . For example, the data 24 may include categorized segments G2₁, G4₂, G6₃, . . . . For example, the data 25 may include categorized segments G2₂, G4₃, G7₁, . . . . For example, the data 26 may include categorized segments G2₃, G5₁, G7₂, . . . . For example, the data 27 may include categorized segments G3₁, G5₂, G7₃, . . . .

A group G1 of data includes the segments G1₁, G1₂, G1₃ . . . , error correction data G1P, and another error correction data G1Q, . . . . A group G2 data includes the segments G2₁, G2₂, G2₃ . . . , error correction data G2P, and another error correction data G2Q, . . . . A group G3 data includes the segments G3₁, G3₂, G3₃ . . . , error correction data G3P, and another error correction data G3Q, . . . . A group G4 data includes the segments G4₁, G4₂, G4₃ . . . , error correction data G4P, and another error correction data G4Q, . . . . A group G5 data includes the segments G5₁, G5₂, G5₃ . . . , error correction data G5P, and another error correction data G5Q, . . . . A group G6 data includes the segments G6₁, G6₂, G6₃ . . . , error correction data G6P, and another error correction data G6Q, . . . . A group G7 data includes the segments G7₁, G7₂, G7₃ . . . , error correction data G7P, and another error correction data G7Q, . . . .

As discussed with reference to FIG. 1, the lookup table(s) 8 may include location information of redundant data (for example, error correction data or parity data) for fault tolerance to secure data integrity.

The error correction data G7P, . . . are stored in the consecutive storage region 16-1B of the storage unit 16-1. The error correction data G5P, . . . are stored in the consecutive storage region 16-2B of the storage unit 16-2. The error correction data G3P, . . . are stored in the consecutive storage region 16-3B of the storage unit 16-3. The error correction data G1P, . . . are stored in the consecutive storage region 16-4B of the storage unit 16-4. The error correction data G6P, . . . are stored in the consecutive storage region 16-5B of the storage unit 16-5. The error correction data G4P, . . . are stored in the consecutive storage region 16-6B of the storage unit 16-6. The error correction data G2P, . . . are stored in the consecutive storage region 16-7B of the storage unit 16-7.

The error correction data G7P, . . . stored in the consecutive storage region 16-1B of the storage unit 16-1 are independent of data segments G1₁, G3₂, G5₃, . . . stored in the consecutive storage region 16-1A of the storage unit 16-1. Any of the error correction data G7P, . . . stored in the consecutive storage region 16-1B of the storage unit 16-1 and the data segments G1₁, G3₂, G5₃, . . . stored in the consecutive storage region 16-1A of the storage unit 16-1 are categorized into different groups.

The error correction data G5P, . . . stored in the consecutive storage region 16-2B of the storage unit 16-2 are independent of data segments G1₂, G3₃, G6₁, . . . stored in the consecutive storage region 16-2A of the storage unit 16-2. Any of the error correction data G5P, . . . stored in the consecutive storage region 16-2B of the storage unit 16-2 and data segments G1₂, G3₃, G6₁, . . . stored in the consecutive storage region 16-2A of the storage unit 16-2 are categorized into different groups.

The error correction data G3P, . . . stored in the consecutive storage region 16-3B of the storage unit 16-3 are independent of data segments G1₃, G4₁, G6₂, . . . stored in the consecutive storage region 16-3A of the storage unit 16-3. Any of the error correction data G3P, . . . stored in the consecutive storage region 16-3B of the storage unit 16-3 and the data segments G1₃, G4₁, G6₂, . . . stored in the consecutive storage region 16-3A of the storage unit 16-3 are categorized into different groups.

The error correction data G1P, . . . stored in the consecutive storage region 16-4B of the storage unit 16-4 are independent of data segments G2₁, G4₂, G6₃, . . . stored in the consecutive storage region 16-4A of the storage unit 16-4. Any of the error correction data G1P, . . . stored in the consecutive storage region 16-4B of the storage unit 16-4 and the data segments G2₁, G4₂, G6₃, . . . stored in the consecutive storage region 16-4A of the storage unit 16-4 are categorized into different groups.

The error correction data G6P, . . . stored in the consecutive storage region 16-5B of the storage unit 16-5 are independent of data segments G2₂, G4₃, G7₁, . . . stored in the consecutive storage region 16-5A of the storage unit 16-5. Any of the error correction data G6P, . . . stored in the consecutive storage region 16-5B of the storage unit 16-5 and the data segments G2₂, G4₃, G7₁, . . . stored in the consecutive storage region 16-5A of the storage unit 16-5 are categorized into different groups.

The error correction data G4P, . . . stored in the consecutive storage region 16-6B of the storage unit 16-6 are independent of data segments G2₃, G5₁, G7₂, . . . stored in the consecutive storage region 16-6A of the storage unit 16-6. Any of the error correction data G-4P, . . . stored in the consecutive storage region 16-6B of the storage unit 16-6 and the data segments G2₃, G5₁, G7₂, . . . stored in the consecutive storage region 16-6A of the storage unit 16-6 are categorized into different groups.

The error correction data G2P, . . . stored in the consecutive storage region 16-7B of the storage unit 16-7 are independent of data segments G3₁, G5₂, G7₃, . . . stored in the consecutive storage region 16-7A of the storage unit 16-7. Any of the error correction data G2P, . . . stored in the consecutive storage region 16-7B of the storage unit 16-7 and the data segments G3₁, G5₂, G7₃, . . . stored in the consecutive storage region 16-7A of the storage unit 16-7 are categorized into different groups.

The error correction data G2Q, . . . are stored in the consecutive storage region 16-1C of the storage unit 16-1. The error correction data G7Q, . . . are stored in the consecutive storage region 16-2C of the storage unit 16-2. The error correction data G5Q, are stored in the consecutive storage region 16-3C of the storage unit 16-3. The error correction data G3Q, . . . are stored in the consecutive storage region 16-4C of the storage unit 16-4. The error correction data G1Q, . . . are stored in the consecutive storage region 16-5C of the storage unit 16-5. The error correction data G6Q, . . . are stored in the consecutive storage region 16-6C of the storage unit 16-6. The error correction data G4Q, . . . are stored in the consecutive storage region 16-7C of the storage unit 16-7.

The error correction data G2Q, . . . stored in the consecutive storage region 16-1C of the storage unit 16-1 are independent of data segments G1₁, G3₂, G5₃, . . . stored in the consecutive storage region 16-1A of the storage unit 16-1. Any of the error correction data G2Q, . . . stored in the consecutive storage region 16-1C of the storage unit 16-1 and the data segments G1₁, G3₂, G5₃, . . . stored in the consecutive storage region 16-1A of the storage unit 16-1 are categorized into different groups. Any of the error correction data G2Q, . . . stored in the consecutive storage region 16-1C of the storage unit 16-1 and error correction data G7P, . . . stored in the consecutive storage region 16-1B of the storage unit 16-1 are categorized into different groups. The data stored in the consecutive storage regions 16-1A, 16-1B, 16-1C and 16-1D are categorized into different groups.

The error correction data G7Q, . . . stored in the consecutive storage region 16-2C of the storage unit 16-2 are independent of data segments G1₂, G3₃, G6₁, . . . stored in the consecutive storage region 16-2A of the storage unit 16-2. Any of the error correction data G7Q, . . . stored in the consecutive storage region 16-2C of the storage unit 16-2 and data segments G1₂, G3₃, G6₁, . . . stored in the consecutive storage region 16-2A of the storage unit 16-2 are categorized into different groups. Any of the error correction data G7Q, . . . stored in the consecutive storage region 16-2C of the storage unit 16-2 and error correction data G5P, . . . stored in the consecutive storage region 16-2B of the storage unit 16-2 are categorized into different groups. The data stored in the consecutive storage regions 16-2A, 16-2B, 16-2C and 16-2D are categorized into different groups.

The error correction data G5Q, . . . stored in the consecutive storage region 16-3C of the storage unit 16-3 are independent of data segments G1₃, G4₁, G6₂, . . . stored in the consecutive storage region 16-3A of the storage unit 16-3. Any of the error correction data G5Q, . . . stored in the consecutive storage region 16-3C of the storage unit 16-3 and the data segments G1₃, G4₁, G6₂, . . . stored in the consecutive storage region 16-3A of the storage unit 16-3 are categorized into different groups. Any of the error correction data G5Q, . . . stored in the consecutive storage region 16-3C of the storage unit 16-3 and error correction data G3P, . . . stored in the consecutive storage region 16-3B of the storage unit 16-3 are categorized into different groups. The data stored in the consecutive storage regions 16-3A, 16-3B, 16-3C and 16-3D are categorized into different groups.

The error correction data G3Q, . . . stored in the consecutive storage region 16-4C of the storage unit 16-4 are independent of data segments G2₁, G4₂, G6₃, . . . stored in the consecutive storage region 16-4A of the storage unit 16-4. Any of the error correction data G3Q, . . . stored in the consecutive storage region 16-4C of the storage unit 16-4 and the data segments G2₁, G4₂, G6₃, . . . stored in the consecutive storage region 16-4A of the storage unit 16-4 are categorized into different groups. Any of the error correction data G3Q, . . . stored in the consecutive storage region 16-4C of the storage unit 16-4 and error correction data G1P, . . . stored in the consecutive storage region 16-4B of the storage unit 16-4 are categorized into different groups. The data stored in the consecutive storage regions 16-4A, 16-4B, 16-4C and 16-4D are categorized into different groups.

The error correction data G1Q, . . . stored in the consecutive storage region 16-5C of the storage unit 16-5 are independent of data segments G2₂, G4₃, G7₁, . . . stored in the consecutive storage region 16-5A of the storage unit 16-5. Any of the error correction data G1Q, . . . stored in the consecutive storage region 16-5C of the storage unit 16-5 and the data segments G2₂, G4₃, G7₁, . . . stored in the consecutive storage region 16-5A of the storage unit 16-5 are categorized into different groups. Any of the error correction data G1Q, . . . stored in the consecutive storage region 16-5C of the storage unit 16-5 and error correction data G6P, . . . stored in the consecutive storage region 16-5B of the storage unit 16-5 are categorized into different groups. The data stored in the consecutive storage regions 16-5A, 16-5B, 16-5C and 16-5D are categorized into different groups.

The error correction data G6Q, . . . stored in the consecutive storage region 16-6C of the storage unit 16-6 are independent of data segments G2₃, G5₁, G7₂, . . . stored in the consecutive storage region 16-6A of the storage unit 16-6. Any of the error correction data G6Q, . . . stored in the consecutive storage region 16-6C of the storage unit 16-6 and the data segments G2₃, G5₁, G7₂, . . . stored in the consecutive storage region 16-6A of the storage unit 16-6 are categorized into different groups. Any of the error correction data G6Q, . . . stored in the consecutive storage region 16-6C of the storage unit 16-6 and error correction data G4P, . . . stored in the consecutive storage region 16-6B of the storage unit 16-6 are categorized into different groups. The data stored in the consecutive storage regions 16-6A, 16-6B, 16-6C and 16-6D are categorized into different groups.

The error correction data G4Q, . . . stored in the consecutive storage region 16-7C of the storage unit 16-7 are independent of data segments G3₁, G5₂, G7₃, . . . stored in the consecutive storage region 16-7A of the storage unit 16-7. Any of the error correction data G4Q, . . . stored in the consecutive storage region 16-7C of the storage unit 16-7 and the data segments G3₁, G5₂, G7₃, . . . stored in the consecutive storage region 16-7A of the storage unit 16-7 are categorized into different groups. Any of the error correction data G4Q, . . . stored in the consecutive storage region 16-7C of the storage unit 16-7 and error correction data G2P, . . . stored in the consecutive storage region 16-7B of the storage unit 16-7 are categorized into different groups. The data stored in the consecutive storage regions 16-7A, 16-7B, 16-7C and 16-7D are categorized into different groups.

If one of the storage units 16-1, 16-2, 16-3, 16-4, 16-5, 16-6 and 16-7 (e.g., the storage unit 16-2) fails, or the segment G1₂ is damaged, the control unit 2 may rebuild or reconstruct the segment G1₂ by the segments G1₁ and G1₃ and the error correction data G1P and G1Q. The control unit 2 may store the rebuilt or reconstructed segment G1₂ in the region G1S in the consecutive region 16-6D of the storage unit 16-6.

If one of the storage units 16-1, 16-2, 16-3, 16-4, 16-5, 16-6 and 16-7 (e.g., the storage unit 16-2) fails, or the segment G3₃ is damaged, the control unit 2 may rebuild or reconstruct the segment G3₃ by the segments G3₁ and G3₂ and the error correction data G3P and G3Q. The control unit 2 may store the rebuilt or reconstructed segment G3₃ in the region G3S in the consecutive region 16-5D of the storage unit 16-5.

If one of the storage units 16-1, 16-2, 16-3, 16-4, 16-5, 16-6 and 16-7 (e.g., the storage unit 16-2) fails, or the segment G6₁ is damaged, the control unit 2 may rebuild or reconstruct the segment G6₁ by the segments G6₂ and G6₃ and the error correction data G6P and G6Q. The control unit 2 may store the rebuilt or reconstructed segment G6₁ in the region G6S in the consecutive region 16-7D of the storage unit 16-7.

By introducing an additional error correction data, the number of failed storage units that can be tolerable by the storage system 16 increases. For example, by using two error correction data (that is, group G1 includes error correction data G1P and G1Q) for a group of data, the number of failed storage units can be tolerable by the storage system 16 is two. Although the loss of data segments may not be recovered due to relatively more failed storage units or relatively more segment losses, the data structure shown in FIG. 5 may help each of the surviving storage units secure data integrity for its unique client or client host.

FIG. 5A, FIG. 5B and FIG. 5C are schematic diagrams of data allocation at various stages to form the data structure as shown in FIG. 5 according to some embodiments of the subject application.

For simplicity, the control unit 2, the transceiving unit 12 and some storage units 16-1, 16-2, 16-3, 16-4, 16-5, 16-6 and 16-7 in the storage system 16 of the apparatus 1 are illustrated in FIG. 5A.

Referring to FIG. 5A, the control unit 2 receives data 21, 22, 23, 24, 25, 26 and 27 through the help of the transceiving unit 12. Each of the data 21, 22, 23, 24, 25, 26 and 27 may be received from a unique client host 14. Each of the data 21, 22, 23, 24, 25, 26 and 27 may be received from multiple client hosts 14. Each of the data 21, 22, 23, 24, 25, 26 and 27 is an object with data integrity, include but not limited to, a file, a directory, a complete file system, a data base, an user profile, or an object storage unit.

Each of the data 21, 22, 23, 24, 25, 26 and 27 may include attribute associated with a unique client host 14. Each of the data 21, 22, 23, 24., 25, 26 and 27 may include attribute associated with a user account. Each of the data 21, 22, 23, 24, 25, 26 and 27 may include attribute associated with a unique internet protocol (IP) address. Each of the data 21, 22, 23, 24, 25, 26 and 27 may include attribute(s) other than the attributes as discussed above.

Prior to data allocation, the data 21 may be segmented and categorized to form the categorized segments G1₁, G3₂, G5₃, . . . . Prior to data allocation, the data 22 may be segmented and categorized to form the G1₂, G3₃, G6₁, . . . . Prior to data allocation, the data 23 may be segmented and categorized to form the categorized segments G1₃, G4₁, G6₂, . . . . Prior to data allocation, the data 24 may be segmented and categorized to form the categorized segments G2₁, G4₂, G6₃, . . . . Prior to data allocation, the data 25 may be segmented and categorized to form the categorized segments G2₂, G4₃, G7₁, . . . . Prior to data allocation, the data 26 may be segmented and categorized to form the categorized segments G2₃, G5₁, G7₂, . . . . Prior to data allocation, the data 27 may be segmented and categorized to form the categorized segments G3₁, G5₂, G7₃, . . . .

Prior to data allocation, the segments G1₁, G1₂, G1₃ and error correction data G1P and G1Q are assigned to a group G1. Prior to data allocation, the spare region G1S is assigned to the group G1. Prior to data allocation, the segments G2₁, G2₂, G2₃ and error correction data G2P and G2Q are assigned to a group G2. Prior to data allocation, the spare region G2S is assigned to the group G2. Prior to data allocation, the segments G3₁, G3₂, G3₃ and error correction data G3P and G3Q are assigned to a group G3. Prior to data allocation, the spare region G3S is assigned to the group G3. Prior to data allocation, the segments G4₁, G4₂, G4₃, and error correction data G4P and G4Q are assigned to a group G4. Prior to data allocation, the spare region G4S is assigned to the group G4. Prior to data allocation, the segments G5₁, G5₂, G5₃, and error correction data G5P and G5Q are assigned to a group G5. Prior to data allocation, the spare region G5S is assigned to the group G5. Prior to data allocation, the segments G6₁, G6₂, G6₃, and error correction data G6P and G6Q are assigned to a group G6. Prior to data allocation, the spare region G6S is assigned to the group G6. Prior to data allocation, the segments G7₁, G7₂, G7₃, and error correction data G7P and G7Q are assigned to a group G7. Prior to data allocation, the spare region G7S is assigned to the group G7.

Data allocation of group G1 is shown in FIG. 5A. The data segment G1₁ is stored in the consecutive storage region 16-1A of the storage unit 16-1. The data segment G1₂ is stored in the consecutive storage region 16-2A of the storage unit 16-2. The data segment G1₃ is stored in the consecutive storage region 16-3A of the storage unit 16-3. The space for storing data segment G1₁ physically or logically corresponds to the space for storing data segment G1₂. The space for storing data segment G1₂ physically or logically corresponds to the space for storing data segment G1₃.

The error correction data G1P, instead of being stored in a space α which physically or logically corresponds to the space for storing data segment G1₁, G1₂ or G1₃, is stored in the consecutive storage region 16-4B of the storage unit 16-4. The space α is in the consecutive storage region 16-4A of the storage unit 16-4. The space α is configured to store data segment of another group (e.g., group G2). The error correction data G1P associated with the group G1 is stored in a storage unit different from those for storing data segments G1₁, G1₂, and G1₃. The error correction data G1P associated with the group G1 is stored in a storage unit next to that for storing the last data segment of the group G1 (e.g., the segment G1₃).

The error correction data G1Q, instead of being stored in a space β which physically or logically corresponds to the space for storing data segment G1₁, G1₂ or G1₃, is stored in the consecutive storage region 16-5C of the storage unit 16-5. The space β is in the consecutive storage region 16-5A of the storage unit 16-5. The space β is configured to store data segment of another group (e.g., group G2). The error correction data G1Q associated with the group G1 is stored in a storage unit different from those for storing data segments G1₁, G1₂, and G1₃ and the error correction data G1P. The error correction data G1Q associated with the group G1 is stored in a storage unit next to that for storing the error correction data G1P.

A space G1S in the consecutive storage region 16-6D of the storage unit 16-6 is configured or reserved to store reconstructed, rebuilt, or recovered segment of the group G1. In other words, the space G1S may function as a spare region to store reconstructed, rebuilt, or recovered segment of the group G1. The spare region G1S associated with the group G1 is allocated in a storage unit different from those for storing data segments G1₁, G1₂, and G1₃ and the error correction data G1P and G1Q. The spare region G1S associated with the group G1 is allocated in a storage unit next to that for storing the error correction data G1Q.

A space π in the consecutive storage region 16-6A of the storage unit 16-6, which physically or logically corresponds to the space β, is configured to store data segment of another group (e.g., group G2).

The allocation of the segments G1₁, G1₂, G1₃, the error correction data G1P and G1Q, and the spare region G1S may be performed at the same time. The allocation of the segments G1₁, G1₂, G1₃, the error correction data G1P and G1Q, and the spare region G1S may be performed in sequence.

Referring to FIG. 5B, for simplicity, only the storage units 16-1, 16-2, 16-3, 16-4, 16-5, 16-6 and 16-7 are illustrated.

Data allocation of group G2 is shown in FIG. 5B. The data segment G2₁ is stored in the space α in the consecutive storage region 16-4A of the storage unit 16-4. The data segment G2₂ is stored in the space β in the consecutive storage region 16-5A of the storage unit 16-5. The data segment G2₃ is stored in the space π of the consecutive storage region 16-6A of the storage unit 16-6.

The error correction data G2P, instead of being stored in a space θ which physically or logically corresponds to the space for storing data segment G2₃, is stored in the consecutive storage region 16-7B of the storage unit 16-7. The space θ is in the consecutive storage region 16-7A of the storage unit 16-7. The space θ is configured to store data segment of another group (e.g. group G3). The error correction data G2P associated with the group G2 is stored in a storage unit different from those for storing data segments G2₁, G2₂, and G2₃. The error correction data G2P associated with the group G2 is stored in a storage unit next to that for storing the last data segment of the group G2 (e.g., the segment G2₃).

The error correction data G2Q, instead of being stored in a space δ, is stored in the consecutive storage region 16-1C of the storage unit 16-1. The space δ is in the consecutive storage region 16-1A of the storage unit 16-1. The space δ is configured to store data segment of another group (e.g., group G3). The error correction data G2Q associated with the group G2 is stored in a storage unit different from those for storing data segments G2₁, G2₂, and G2₃ and the error correction data G2P. The error correction data G2Q associated with the group G2 is stored in a storage unit next to that for storing the error correction data G2P.

A space G2S in the consecutive storage region 16-2D of the storage unit 16-2 is configured or reserved to store reconstructed, rebuilt, or recovered segment of the group G2. In other words, the space G2S may function as a spare region to store reconstructed, rebuilt, or recovered segment of the group G2. A space λ in the consecutive storage region 16-2A of the storage unit 16-2, which physically or logically corresponds to the space δ, is configured to store data segment of another group (e.g. group G3). The spare region G2S associated with the group G2 is allocated in a storage unit different from those for storing data segments G2₁, G2₂, and G2₃ and the error correction data G2P and G2Q. The spare region G2S associated with the group G2 is allocated in a storage unit next to that for storing the error correction data G2Q.

The allocation of the segments G2₁, G2₂, G2₃, the error correction data G2P and G2Q, and the spare region G2S may be performed at the same time. The allocation of the segments G2₁, G2₂, G2₃, the error correction data G2P and G2Q, and the spare region G2S may be performed in sequence.

Referring to FIG. 5C, for simplicity, only the storage units 16-1, 16-2, 16-3, 16-4, 16-5, 16-6 and 16-7 are illustrated. Data allocation of groups G3, G4, G5, G6 and G7 is shown in FIG. 5C.

The data segment G3₁ of data 27 is stored in the consecutive storage region 16-7A of the storage unit 16-7. The data segment G3₂ of data 21 is stored in the consecutive storage region 16-1A of the storage unit 16-1. The data segment G3₃ of data 22 is stored in the consecutive storage region 16-2A of the storage unit 16-2.

Therefore, segments of data 21 (e.g. segments G1₁, G3₂, G5₃ . . . ) are stored in the consecutive storage region 16-1A of the storage unit 16-1; segments of data 22 (e.g. segments G1₂, G3₃, G6₁ . . . ) are stored in the consecutive storage region 16-2A of the storage unit 16-2; segments of data 23 (e.g. segments G1₃, G4₁, G6₂ . . . ) are stored in the consecutive storage region 16-3A of the storage unit 16-3; segments of data 24 (e.g., segments G2₁, G4₂, G6₃, . . . ) are stored in the consecutive storage region 16-4A of the storage unit 16-4; segments of data 25 (e.g., segments G2₂, G4₃, G7₁, . . . a stored in the consecutive storage region 16-5A of the storage unit 16-5; segments of data 26 (e.g. segments G2₃, G5₁, G7₂, . . . ) are stored in the consecutive storage region 16-6A of the storage unit 16-6; and segments of data 27 (e.g. segments G3₁, G5₂, G7₃, . . . ) are stored in the consecutive storage region 16-7A of the storage unit 16-7.

The error correction data (e.g. G3P and G3Q) of a group (e.g. G3) is stored in a storage unit (e.g., 16-3 and 16-4) different from a storage unit (e.g., 16-7, 16-1 or 16-2) where the data segment (e.g., segment G3₁, G3₂ or G3₃) in the same group is stored. The error correction data (e.g., G4P and G4Q) of a group (e.g. G4) is stored in a consecutive storage region (e.g., 16-6B and 16-7C) physically or logically different from a consecutive storage region (e.g., 16-3A, 16-4A or 16-5A) where the data segment in the same group (e.g., segment G4₁, G4₂ or G4₃) is stored.

A space (e.g., G3S) is configured in a consecutive storage region (e.g., 16-5D) physically or logically different from a consecutive storage region (e.g., 16-7A, 16-1A or 16-2A) where the data segment in the same group (e.g., segment G3₁, G3₂ or G3₃) is stored. A space (e.g., G4S) is configured in a storage unit (e.g., 16-1) different from a storage unit (e.g., 16-3, 16-4 or 16-5) where the data segment (e.g., segment G4₁, G4₂ or G4₃) in the same group is stored. A space (e.g., G4S) is configured in a storage unit (e.g., 16-1) different from a storage unit (e.g., 16-6 or 16-7) where the error correction data (e.g., G4P and G4Q) in the same group is stored. A space (e.g., G5S) in a consecutive storage region (e.g., 16-4D) of a storage unit (e.g., 16-4) is configured or reserved to store reconstructed, rebuilt, or recovered segment of the same group (e.g., G5).

The allocation of data in different groups may be performed at the same time. The allocation of data in different groups may be performed in sequence. The allocation of data in different groups may be performed in numerical order.

The data segment, error correction data, and spare region of the following groups (e.g., groups G4, G5, G6, G7, . . . ) are allocated, configured or stored by a rule or pattern analogous to the above.

In the embodiments as shown in FIG. 5, FIG. 5A, FIG. 5B or FIG. 5C, the number of storage units (e.g., 7) and the number of data segments in a group (e.g., 3) is co-prime. However, the number of storage units and the number of data segments in a group may not be co-prime in accordance with some embodiments of the subject application.

FIG. 6A is a schematic diagram illustrating data structure in a storage system according to some embodiments of the subject application. For simplicity, the control unit 2, the transceiving unit 12 and some storage units 16-1, 16-2, 16-3, 16-4, 16-5 and 16-6 in the storage system 16 of the apparatus 1 are illustrated in FIG. 6A.

In the embodiments as shown in FIG. 6A, the number of storage units (e.g., 6) and the number of data segments in a group (e.g., 3) is not co-prime.

Referring to FIG. 6A, the control unit 2 receives data 21, 22, 23, 24, 25 and 26 through the help of the transceiving unit 12. Each of the data 21, 22, 23, 24, 25 and 26 may be received from a unique client host 14. Each of the data 21, 22, 23, 24, 25 and 26 may be received from multiple client hosts 14. Each of the data 21, 22, 23, 24, 25 and 26 is an object with data integrity, include but not limited to, a file, a directory, a complete file system, a data base, an user profile, or an object storage unit.

Each of the data 21, 22, 23, 25 and 26 may include attribute associated with a unique client host 14. Each of the data 21, 22, 23, 24, 25 and 26 may include attribute associated with a user account. Each of the data 21. 22, 23, 24, 25 and 26 may include attribute associated with a unique Internet protocol (IP) address. Each of the data 21, 22, 23, 24, 25 and 26 may include attribute(s) other than the attributes as discussed above.

The control unit may store the data 21, 22, 23, 24, 25 and 26 in accordance with the lookup table(s) 8 as shown in FIG. 1. The control unit 2 stores the data 21 in the storage unit 16-1. The control unit 2 stores the data 22 in the storage unit 16-2. The control unit 2 stores the data 23 in the storage unit 16-3. The control unit 2 stores the data 24 in the storage unit 16-4. The control unit 2 stores the data 25 in the storage unit 16-5. The control unit 2 stores the data 26 in the storage unit 16-6.

The control unit 2 stores the data 21 in the consecutive storage region 16-1A. The control unit 2 stores the data 22 in the consecutive storage region 16-2A. The control unit 2 stores the data 23 in the consecutive storage region 16-3A. The control unit 2 stores the data 24 in the consecutive storage region 16-4A. The control unit 2 stores the data 25 in the consecutive storage region 16-5A. The control unit 2 stores the data 26 in the consecutive storage region 16-6A.

Prior to data allocation, the data 21, 22, 23, 24, 25 and 26 may be segmented and categorized. Prior to data allocation, error correction data and spare region are assigned to the data 21, 22, 23, 24, 25 and 26. The data segment, error correction data, and spare region of the groups G1, G2, G3, G4, G5, G6 . . . as shown in FIG. 6A are allocated, configured or stored by a rule or pattern analogous to those as illustrated above in accordance with FIG. 3, FIG. 3A, FIG. 3B or FIG. 3C.

As shown in FIG. 6A, in the case that the number of storage units and the number of data segments in a group is not co-prime, the error correction data for different groups (e.g., G2P, G4P and G6P; G1P, G3P and G5P) will concentrate in only some of the storage units (e.g., storage units 16-1 and 16-4) rather than equally spread among the storage units. In addition, the spare regions will also concentrate in only some of the storage units (e.g., storage units 16-2 and 16-5) rather equally spread among the storage units.

The congested distribution of the error correction data in some of the storage units will adversely affect the performance, capacity usage and reliability-of the storage system. In order to maintain the error correction ability, the error correction data may be frequently updated once any one of the segments stored in the consecutive storage regions 16-1A, 16-2A, . . . , and 16-6A changes. For example, the error correction data G2P may be updated once any one of the segments G2₁, G2₂ and G2₃ changes. Similarly, the error correction data G4P may be updated once any one of the segments G4₁, G4₂ and G4₃ changes. The error correction data G6P may be updated once any one of the segments G6₁, G6₂ and G6₃ changes.

The congested distribution of the error correction data increases the read/write operations necessary for the storage unit 16-1 and eventually decreases the lifetime of the storage unit 16-1. The centralized distribution of the error correction data increases the read/write operations necessary for the storage unit 16-4 and eventually decreases the lifetime of the storage unit 16-4.

FIG. 6B is a schematic diagram illustrating data structure in a storage system according to some embodiments of the subject application. For simplicity, only the storage units 16-1, 16-2, 16-3, 16-4, 16-5 and 16-6 are illustrated. Data allocation of groups G1, G2, G3, G4, G5 and G6 is shown in FIG. 6B.

The segments G1₁, G1₂ and G1₃ are stored in the consecutive storage regions 16-1A, 16-2A and 16-3A, respectively. The segments G2₁, G2₂ and G2₃ are stored in the consecutive storage regions 16-4A, 16-5A and 16-6A, respectively. The segments G3₁, G3₂ and G3₃ are stored in the consecutive storage regions 16-1A, 16-2A and 16-3A, respectively. The segments G4₁, G4₂ and G4₃ are stored in the consecutive storage regions 16-4A, 16-5A and 16-6A, respectively. The segments G5₁, G5₂ and G5₃ are stored in the consecutive storage regions 16-1A, 16-2A and 16-3A, respectively. The segments G6₁, G6₂ and G6₃ are stored in the consecutive storage regions 16-4A, 16-5A and 16-6A, respectively.

The data segments of the groups G1, G2, G3, G4, G5 and G6 are allocated, configured or stored by a rule or pattern identical to that of FIG. 6A.

However, in FIG. 6B, the error correction data G1P, G2P, G3P, G4P, G5P and G6P of the groups G1, G2, G3, G4, G5 and G6 are allocated to be equally spread over the storage units 16-1 to 16-6. In addition, the spare regions G1S, G2S, G3S, G4S, G5S and G6S of the groups G1, G2, G3, G4, G5 and G6 are allocated to be equally spread over the storage units 16-1 to 16-6.

The error correction data G1P, G2P, G3P, G4P, G5P and G6P may be allocated in accordance with the lookup table(s) 8 as shown in FIG. 1. The error correction data G1P, G2P, G3P, G4P, G5P and G6P may be allocated in accordance with an algorithm that equally fill error correction data in consecutive storage regions of the storage units. The error correction data G1P, G2P, G3P, G4P, G5P and G6P may be allocated in accordance with the computation results of the control unit 2 or the acceleration unit 4.

The spare regions G1S, G2S, G3S, G4S, G5S and G6S may be allocated in accordance with the lookup table(s) 8 as shown in FIG. 1. The spare regions G1S, G2S, G3S, G4S, G5S and G6S may be allocated in accordance with an algorithm that equally fills error correction data in consecutive storage regions of the storage units. The spare regions G1S, G2S, G3S, G4S, G5S and G6S may be allocated in accordance with the computation results of the control unit 2 or the acceleration unit 4.

As shown in FIG. 6B, the error correction data G4P, instead of being stored in a space α in the consecutive storage region 16-1B, is stored in the consecutive storage region 16-2B of the storage unit 16-2. The error correction data G6P, instead of being stored in a space β in the consecutive storage region 16-1B, is stored in the consecutive storage region 16-3B of the storage unit 16-3. The space α is physically or logically adjacent or next to the space that stores the error correction data G2P. The space β is physically or logically adjacent or next to the space α.

The error correction data G3P, instead of being stored in a space θ in the consecutive storage region 16-4B, is stored in the consecutive storage region 16-5B of the storage unit 16-5. The error correction data G5P, instead of being stored in a space δ in the consecutive storage region 16-4B, is stored in the consecutive storage region 16-6B of the storage unit 16-6. The space θ is physically or logically adjacent or next to the space that stores the error correction data G1P. The space δ is physically or logically adjacent or next to the space θ.

The spare region G4S, instead of being allocated in a space λ in the consecutive storage region 16-2B, is stored in the consecutive storage region 16-3B of the storage unit 16-3. The spare region G6S, instead of being allocated in a space μ in the consecutive storage region 16-2B, is stored in the consecutive storage region 16-4B of the storage unit 16-4. The space λ is physically or logically adjacent or next to the space that allocated to the pare region G2S. The space μ is physically or logically adjacent or next to the space λ.

The spare region G3S, instead of being allocated in a space ε in the consecutive storage region 16-5B, is stored in the consecutive storage region 16-6B of the storage unit 16-6. The spare region G5S, instead of being allocated in a space π in the consecutive storage region 16-5B, is stored in the consecutive storage region 16-1B of the storage unit 16-1. The space ε is physically or logically adjacent or next to the space that allocated to the pare region G1S. The space π is physically or logically adjacent or next to the space ε.

The data structure as shown in FIG. 6B equally spreads the error correction data to the consecutive storage regions 16-1B, 16-2B, 16-3B, 16-4B, 16-5B and 16-6B. The balanced allocation of the error correction data ensures that the read/write workload will not be concentrated in only some of the storage units and thus can prolong the lifetime of the storage units and the system.

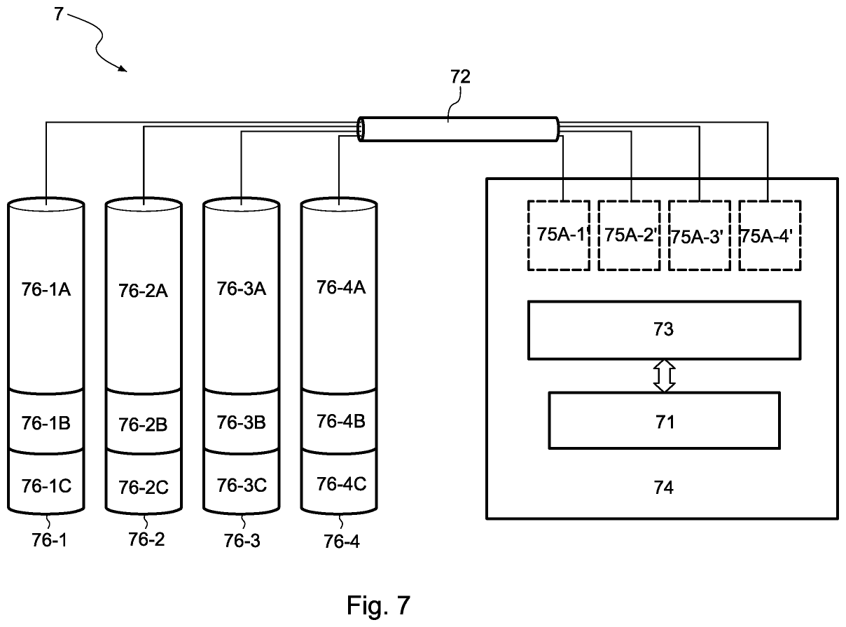

FIG. 7 is a schematic diagram illustrating another apparatus according to some embodiments of the subject application. The apparatus 7 includes the storage units 76-1 to 76-4 and a client host 74 that are electrically connected through a transceiving unit 72. Although four storage units are shown in FIG. 7, it can be contemplated that the apparatus 7 may include more storage units or fewer storage units. The storage unit 76-1 includes consecutive storage regions 76-1A, 76-1B and 76-1C. The storage unit 76-2 includes consecutive storage regions 76-2A, 76-2B and 76-2C. The storage unit 76-3 includes consecutive storage regions 76-3A, 76-33 and 76-3C. The storage unit 76-4 includes consecutive storage regions 76-4A, 76-4B and 76-4C.

Client data received from the client host 74 will be stored in the consecutive storage regions 76-1A, 76-2A, 76-3A and 76-4A.

Error correction data are stored in the consecutive storage regions 76-1B, 76-2B, 76-3B and 76-4B. The consecutive storage regions 76-1C, 76-2C, 76-3C and 76-4C are designated as spare regions to be used in the data reconstruction process. The data allocation mechanism in the apparatus 7 may be identical or similar to any of those that have been explained and illustrated in accordance with FIGS. 3, 3A, 3B, 3C, 5, 5A, 5B, 5C, 6, 6A and 6B.

In the embodiment shown in FIG. 7, all the storage units 76-1, 76-2, 76-3 and 76-4 may be dedicated to a single client host 74. The client host 74 is able to access the storage units 76-1 to 76-4 through the transceiving unit 72. From the viewpoint of the client host 74, the consecutive storage regions 76-1A, 76-2A, 76-3A and 76-4A in the apparatus 7 can be deemed as local storage units 75A-1′, 75A-2′, 75A-3′ and 75A-4′ by the client host 74.

An application 71 that requires high-speed data read/write operations runs on the client host 74. In order to fulfill the data throughput requirements of the application 71, the client host 74 includes a pseudo-device driver 73 that can provide RAID functionality such as RAID level 0. In some embodiments, the pseudo-device driver 73 is implemented in a memory device (not shown) of the client host 74. In some embodiments, the pseudo-device driver 73 is implemented in a cache unit (not shown) within a memory device of the client host 74.

It is known that the RAID level 0 has the highest speed compared to the other RAID levels but it cannot provide data integrity. In the apparatus 7, data integrity is provided by the consecutive storage regions 76-1B, 76-2B, 76-3B and 76-4B of the storage units 76-1, 76-2, 76-3 and 76-4. Therefore, the client host 74 can simply take care of the data throughput requirements of the application 71 and does not need to worry about the data integrity among the local storage units 75A-1′, 75A-2′, 75A-3′ and 75A-4′.

RAID level migration may refer to change of storage space configuration in some storage units from one RAID level to another RAID level. For example, RAID level migration may refer to change of storage space configuration from RAID level 5 to RAID level 6 in the RAID level migration process. RAID level migration is time-consuming because majority or all of the data stored in the storage units have to be rearranged, moved or reallocated. In addition, data may be susceptible to damage during migration process which involves data rearrangement or data moving, and the damaged data may not be recovered.

The proposed storage space configurations, as described in accordance with FIG. 2, FIG. 4 and FIG. 7, provides flexibility in level migration process of storage units. During level migration process, data stored in the consecutive storage regions 16-1A, 16-2A . . . 16-NA, 76-1A, 76-2A, 76-3A and 76-4A remain or stay in same region. In other words, majority of data are not rearranged or moved. In addition, number of storage regions for storing additional error correction data can be changed as desired.

By using one storage region (e.g., 16-1B, 16-2B, . . . 16-NB, 76-1B, 76-2B, 76-3B and 76-4B) in each storage unit for storing error correction data, the apparatuses shown in FIG. 2 and FIG. 7 can tolerate failure of one drive. If one additional (or extra) storage region (e.g., 16-1C, 16-2C . . . 16-NC as shown in FIG. 4) in each storage unit is used for storing additional (or extra) error correction data (which means two storage regions for storing different error correction data), the apparatus shown in FIG. 4 can tolerate failure of two drive. It is contemplated that more storage regions can be configured to store other error correction data.

Even the amount of error correction data changes, data allocation in the consecutive storage regions 16-1A, 16-2A . . . 16-NA, 76-1A, 76-2A, 76-3A and 76-4A stay unchanged.

Because data stored in the consecutive storage regions 16-1A, 16-2A . . . 16-NA, 76-1A, 76-2A, 76-3A and 76-4A are not moved during level migration process, time of level migration in the apparatuses shown in FIG. 2, FIG. 4 and FIG. 7 can be significantly reduced. Assuming that 4 storage units are included in the array and each storage unit has a capacity of 100 TB, it is expected that 400 TB of data needs to be processed (e.g., read and write) in the legacy RAID level migration process (for example, RAID level 0 to RAID level 5).

However, in the apparatuses shown in FIG. 2, FIG. 4 and FIG. 7, assuming that the storage region (e.g., 16-1B, 16-2B . . . 16-NB, 76-1B, 76-2B, 76-3B and 76-4B) in each storage unit each has a capacity of 25 TB, only 100 TB of error correction data needs to be generated and written to the storage region. It is expected that the speed of data migration will increases by 4 times because less data is removed, rearranged or reallocated.

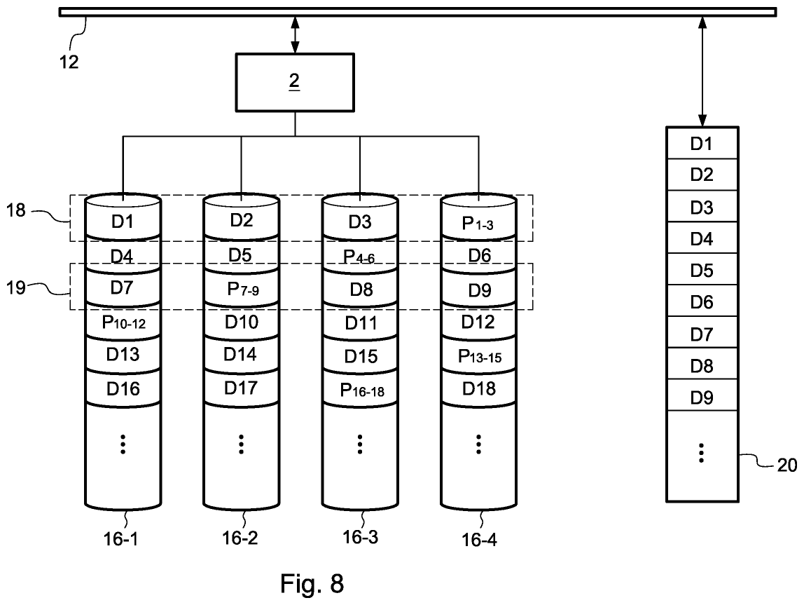

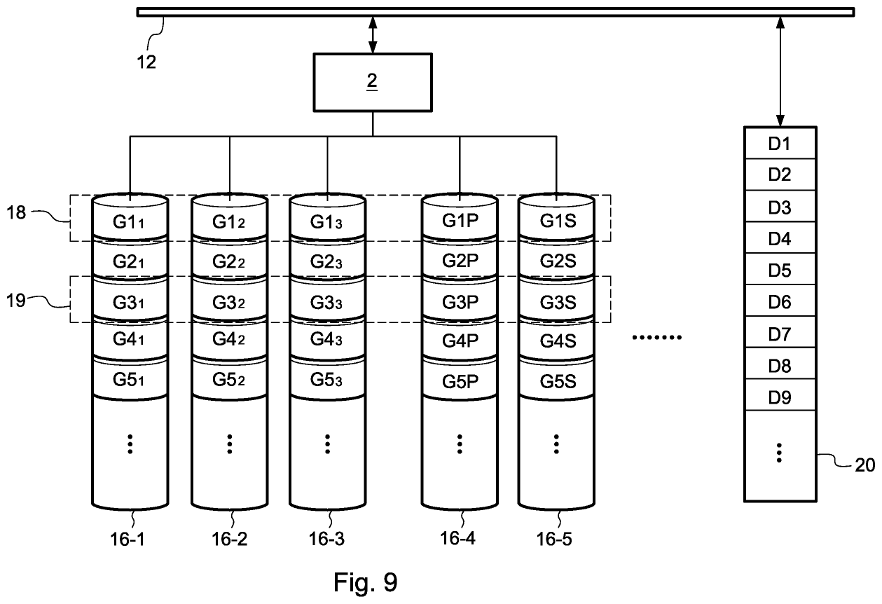

The advantage of the apparatuses shown in FIG. 2, FIG. 4 and FIG. 7 would be even clearer when it is compared to the comparative embodiments described in accordance with FIG. 8 and FIG. 9.

FIG. 8 is a schematic diagram illustrating a storage space configuration according to some comparative embodiments of the subject application.

For simplicity, the control unit 2, the transceiving unit 12 and some storage units 16-1, 16-2, 16-3 and 16-4 in the storage system 16 of the apparatus 1 are illustrated in FIG. 8.

Referring to FIG. 8, the control unit 2 receives data 20 through the help of the transceiving unit 12. The data 20 may be received from a single client host 14. The data 20 may be received from multiple client hosts 14. The data 20 may include attribute associated with a client host 14. The data 20 may include attribute associated with a user account. The data 20 may include attribute associated with an internet protocol (IP) address. The data 20 may include attribute(s) other than the attributes as discussed above.

The control unit stores the data 20 in the storage units 16-1, 16-2, 16-3 and 16-4. The control unit may store the data 20 in the storage units 16-1, 16-2, 16-3 and 16-4 in accordance with the lookup table(s) 8 as shown in FIG. 1.

The data 20 may be divided into segments and then stored in the storage units 16-1, 16-2, 16-3 and 16-4. For example, the data 20 are divided into segments D1, D2, D3, D4 . . . and so on. The data 20 may be divided by, for example but is not limited to, data striping technique.

As discussed with reference to FIG. 1, the lookup table(s) 8 may include location information of redundant data (for example, error correction data or parity data) for fault tolerance to secure data integrity.

Referring to FIG. 8, error correction data P₁₋₃ are stored in the storage unit 16-4. The error correction data P₁₋₃ are associated with the segments D1, D2 and D3, which are stored in the storage units 16-1, 16-2 and 16-3, respectively. The segments D1, D2 and D3 and the error correction data P₁₋₃ form a group 18.

A region or space of the storage unit 16-1 to store the segment D1 of the data 20 logically or physically corresponds to a region or space of the storage unit 16-2 to store the segment D2 of the data 20. A region or space of the storage unit 16-1 to store the segment D1 of the data 20 logically or physically corresponds to a region or space of the storage unit 16-3 to store the segment D3 of the data 20. A region or space of the storage unit 16-1 to store the segment D1 of the data 20 logically or physically corresponds to a region or space of the storage unit 16-4 to store the error correction data P₁₋₃.

A region or space of the storage unit 16-2 to store the segment D2 of the data 20 logically or physically corresponds to a region or space of the storage unit 16-3 to store the segment D3 of the data 20. A region or space of the storage unit 16-2 to store the segment D2 of the data 20 logically or physically corresponds to a region or space of the storage unit 16-4 to store the error correction data P₁₋₃.

A region or space of the storage unit 16-3 to store the segment D3 of the data 20 logically or physically corresponds to a region or space of the storage unit 16-4 to store the error correction data P₁₋₃.

A region or space of the storage unit 16-1 to store the segment D1 of the data 20 horizontally or elevationally corresponds to a region or space of the storage unit 16-2 to store the segment D2 of the data 20. A region or space of the storage unit 16-1 to store the segment D1 of the data 20 horizontally or elevationally corresponds to a region or space of the storage unit 16-3 to store the segment D3 of the data 20. A region or space of the storage unit 16-1 to store the segment D1 of the data 20 horizontally or elevationally corresponds to a region or space of the storage unit 16-4 to store the error correction data P₁₋₃.

A region or space of the storage unit 16-2 to store the segment D2 of the data 20 horizontally or elevationally corresponds to a region or space of the storage unit 16-3 to store the segment D3 of the data 20. A region or space of the storage unit 16-2 to store the segment D2 of the data 20 horizontally or elevationally corresponds to a region or space of the storage unit 16-4 to store the error correction data P₁₋₃.

A region or space of the storage unit 16-3 to store the segment D3 of the data 20 horizontally or elevationally corresponds to a region or space of the storage unit 16-4 to store the error correction data P₁₋₃.

For example, addresses [XX0001], [XX0002], [XX0003], [XX0004] and [XX0005] of the storage unit 16-1 are used to store the segment D1 of the data 20, addresses [XX0001], [XX0002], [XX0003], [XX0004] and [XX0005] of the storage unit 16-2 are used to store the segment D2 of the data 20, addresses [XX0001], [XX0002], [XX0003], [XX0004] and [XX0005] of the storage unit 16-3 are used to store the segment D3 of the data 20, addresses [XX0001], [XX0002], [XX0003], [XX0004] and [XX0005] of the storage unit 16-4 are used to store the error correction data P₁₋₃.

For example, sectors 1, 2, 3, 4 and 5 of track 1 of the storage unit 16-1 are used to store the segment D1 of the data 20, sectors 1, 2, 3, 4 and 5 of track 1 of the storage unit 16-2 are used to store the segment D2 of the data 20, sectors 1, 2, 3, 4 and 5 of track 1 of the storage unit 16-3 are used to store the segment D3 of the data 20, sectors 1, 2, 3, 4 and 5 of track 1 of the storage unit 16-4 are used to store the error correction data P₁₋₃.

The error correction data P₁₋₃ may include even parity data associated with the segments D1, D2 and D3. The error correction data P₁₋₃ may include odd parity data associated with the segments D1, D2 and D3. It can be contemplated that P₁₋₃ may include any other error correction data adopted by other fault tolerance techniques.

If one of the storage units 16-1, 16-2 and 16-3 (e.g., the storage unit 16-1) fails, or the segment D1 is damaged, the control unit 2 may rebuild or reconstruct the segment D1 by the segments D2 and D3 and the error correction data P₁₋₃.

Similar to the data structure as discussed, the segments D7, D8 and D9 and the error correction data P₇₋₉ may form another group 19. If one of the storage units 16-1, 16-3 and 16-4 (e.g., the storage unit 16-4) fails, or the segment D9 is damaged, the control unit 2 may rebuild or reconstruct the segment D9 by the segments D7 and D8 and the error correction data P₇₋₉.

However, if two or more of the storage units 16-1, 16-3 and 16-4 (e.g., the storage units 16-3 and 16-4) fails, or the segments D8 and D9 are damaged, the control unit 2 may not rebuild or reconstruct the segments D8 and D9 by the segment D7 and the error correction data P₇₋₉.

In other words, if the number of failed storage units or damaged segments of data exceeds a threshold (e.g., two in this embodiment), the lost data segments D8 and D9 cannot be recovered, which adversely affects integrity of the data 20.

For example, each of the storage units 16-1, 16-2, 16-3 and 16-4 may include a storage space up to 100 terabytes (TB) or more. The lost data segments D8 and D9 may jeopardize integrity of data 20, which may have a size up to 400 TB. Failure of the storage units 16-3 and 16-4 may result in data loss of up to 400 TB.

FIG. 9 is a schematic diagram illustrating another storage space configuration according to some comparative embodiments of the subject application.

For simplicity, the control unit 2, the transceiving unit 12 and some storage units 16-1, 16-2, 16-3, 16-4 and 16-5 in the storage system 16 of the apparatus 1 are illustrated in FIG. 9.

Referring to FIG. 9, the received data 20 are divided into segments G1₁, G1₂, G1₃, G2₁, G2₂, G2₃, G3₁, G3₂, G3₃, G4₁, G4₂, G4₃, G5₁, G5₂, G5₃, . . . , which are stored in the storage units 16-1, 16-2 and 16-3. The error correction data G1P, G2P, G3P, G4P, G5P . . . are stored in the single storage unit 16-4. The storage unit 16-5 is configured to reserve spare regions G1S, G2S, G3S, G4S, G5S, . . . to store reconstruction segments of the data 20.

A region or space of the storage unit 16-1 to store the segment G1₁ of the data 20 logically or physically corresponds to a region or space of the storage unit 16-2 to store the segment G1₂ of the data 20. A region or space of the storage unit 16-1 to store the segment G1₁ of the data 20 logically or physically corresponds to a region or space of the storage unit 16-3 to store the segment G1₃ of the data 20. A region or space of the storage unit 16-1 to store the segment G1₁ of the data 20 logically or physically corresponds to a region or space of the storage unit 16-4 to store the error correction data G1_{P}. A region or space of the storage unit 16-1 to store the segment G1₁ of the data 20 logically or physically corresponds to a region or space G1S of the storage unit 16-5.

A region or space of the storage unit 16-2 to store the segment G1₂ of the data 20 logically or physically corresponds to a region or space of the storage unit 16-3 to store the segment G1₃ of the data 20. A region or space of the storage unit 16-2 to store the segment G1₂ of the data 20 logically or physically corresponds to a region or space of the storage unit 16-4 to store the error correction data G1_{P}. A region or space of the storage unit 16-2 to store the segment G1₂ of the data 20 logically or physically corresponds to a region or space G1S of the storage unit 16-5.

A region or space of the storage unit 16-3 to store the segment G1₃ of the data 20 logically or physically corresponds to a region or space of the storage unit 16-4 to store the error correction data G1_{P}. A region or space of the storage unit 16-3 to store the segment G1₃ of the data 20 logically or physically corresponds to a region or space G1S of the storage unit 16-5. A region or space of the storage unit 16-4 to store the error correction data G1_{P} logically or physically corresponds to a region or space G1S of the storage unit 16-5.

A region or space of the storage unit 16-1 to store the segment G1₁ of the data 20 horizontally or elevationally corresponds to a region or space of the storage unit 16-2 to store the segment G1₂ of the data 20. A region or space of the storage unit 16-1 to store the segment G1₁ of the data 20 horizontally or elevationally corresponds to a region or space of the storage unit 16-3 to store the segment G1₃ of the data 20. A region or space of the storage unit 16-1 to store the segment G1₁ of the data 20 horizontally or elevationally corresponds to a region or space of the storage unit 16-4 to store the error correction data G1_{P}. A region or space of the storage unit 16-1 to store the segment G1₁ of the data 20 horizontally or elevationally corresponds to a region or space G1S of the storage unit 16-5.

A region or space of the storage unit 16-2 to store the segment G1₂ of the data 20 horizontally or elevationally corresponds to a region or space of the storage unit 16-3 to store the segment G1₃ of the data 20. A region or space of the storage unit 16-2 to store the segment G1₂ of the data 20 horizontally or elevationally corresponds to a region or space of the storage unit 16-4 to store the error correction data G1_{P}. A region or space of the storage unit 16-2 to store the segment G1₂ of the data 20 horizontally or elevationally corresponds to a region or space G1S of the storage unit 16-5.

A region or space of the storage unit 16-3 to store the segment G1₃ of the data 20 horizontally or elevationally corresponds to a region or space of the storage unit 16-4 to store the error correction data G1_{P}. A region or space of the storage unit 16-3 to store the segment G1₃ of the data 20 horizontally or elevationally corresponds to a region or space G1S of the storage unit 16-5. A region or space of the storage unit 16-4 to store the error correction data G1_{P} horizontally or elevationally corresponds to a region or space G1S of the storage unit 16-5.

For example, addresses [XX0001], [XX0002], [XX0003], [XX0004] and [XX0005] of the storage unit 16-1 are used to store the segment G1₁ of the data 20, addresses [XX0001], [XX0002], [XX0003], [XX0004] and [XX0005] of the storage unit 16-2 are used to store the segment G1₂ of the data 20, addresses [XX0001], [XX0002], [XX0003], [XX0004] and [XX0005] of the storage unit 16-3 are used to store the segment G1₃ of the data 20, addresses [XX0001], [XX0002], [XX0003], [XX0004] and [XX0005] of the storage unit 16-4 are used to store the error correction data G1_{P}, addresses [XX0001], [XX0002], [XX0003], [XX0004] and [XX0005] of the storage unit 16-5 are configured as region G1S.

For example, sectors 1, 2, 3, 4 and 5 of track 1 of the storage unit 16-1 are used to store the segment G1₁ of the data 20, sectors 1, 2, 3, 4 and 5 of track 1 of the storage unit 16-2 are used to store the segment G1₂ of the data 20, sectors 1, 2, 3, 4 and 5 of track 1 of the storage unit 16-3 are used to store the segment G1₃ of the data 20, sectors 1, 2, 3, 4 and 5 of track 1 of the storage unit 16-4 are used to store the error correction data G1P, and sectors 1, 2, 3, 4 and 5 of track 1 of the storage unit 16-4 are configured as region G1S.

The error correction data G1P, G2P, G3P, G4P, G5P . . . may include even parity data associated with the segments D1, D2 and D3. The error correction data G1P, G2P, G3P, G4P, G5P may include odd parity data associated with the segments D1, D2 and D3. It can be contemplated that G1P, G2P, G3P, G4P, G5P . . . may include any other error correction data adopted by other fault tolerance techniques.

The segments G1₁, G1₂ and G1₃ and the error correction data G1P may form another group 18. If one of the storage units 16-1, 16-2 and 16-3 (e.g., the storage unit 16-1) fails, or the segment G1₁ is damaged, the control unit 2 may rebuild or reconstruct the segment G1₁ by the segments G1₂ and G1₃ and the error correction data G1P. The control unit 2 may store the rebuilt or reconstructed segment G1₁ in the region G1S of the storage unit 16-5.

Similar to the data structure as discussed, the segments G3₁, G3₂ and G3₃ and the error correction data G3P may form another group 19. If one of the storage units 16-1, 16-2 and 16-3 (e.g., the storage unit 16-3) fails, or the segment G3₃ is damaged, the control unit 2 may rebuild or reconstruct the segment G3₃ by the segments G3₁ and G3₂ and the error correction data G3P. The control unit 2 may store the rebuilt or reconstructed segment G3₃ in the region G3S of the storage unit 16-5.

However, the storage unit 16-4 may suffer heavy workload or throughput because all the error correction data G1P, G2P, G3P, G4P, G5P . . . are stored in the single storage unit 16-4. The error correction data G1P, G2P, G3P, G4P, G5P . . . need to be updated frequently in order to maintain their error correction functions. For example, when the data included by any one of segments G1₁, G1₂ and G1₃ changes, the error correction data G1P may need to update accordingly. Such phenomenon may reduce the lifetime of the storage unit 16-4.

The storage unit 16-5 does not work unless there are data to be stored therein. Accordingly, the storage unit 16-5, which is in an idle state at most of time, may adversely affect optimization of storage efficiency.

However, if two or more of the storage units 16-1, 16-2 and 16-3 (e.g., the storage units 16-2 and 16-3) fails, or the segments G3₂ and G3₃ are damaged, the control unit 2 may not rebuild or reconstruct the segments G3₂ and G3₃ by the segment G3₁ and the error correction data G3_{P}.

In other words, if the number of failed storage units or damaged segments of data exceeds a threshold (e.g., two in this embodiment), the lost data segments G3₂ and G3₃ cannot be recovered, which adversely affects integrity of the data 20.

For example, each of the storage units 16-1, 16-2, and 16-3 may include a storage space up to 100 terabytes (TB) or more. The lost data segments G3₂ and G3₃ may jeopardize integrity of data 20, which may have a size up to 300 TB. Failure of the storage units 16-2 and 16-3 may result in data loss of up to 300 TB.

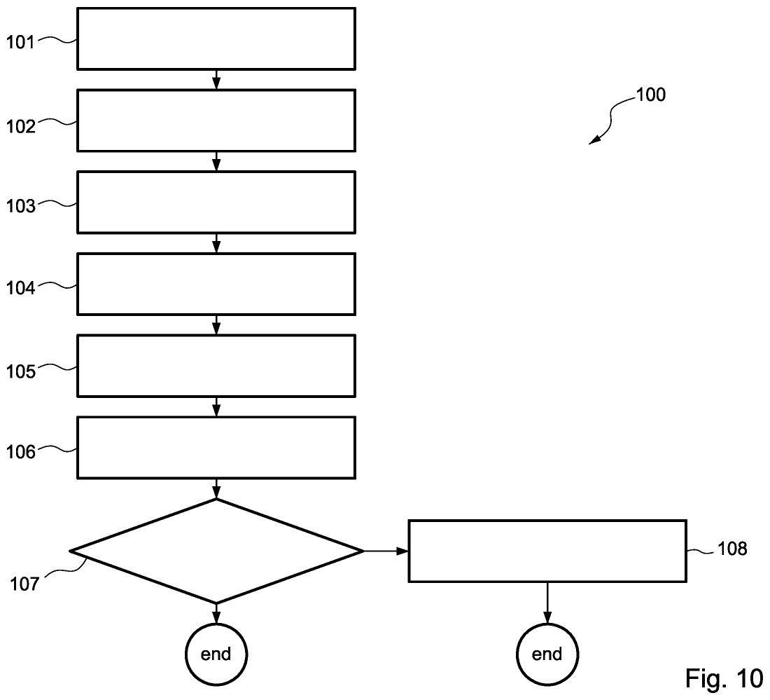

FIG. 10 is a flow chart illustrating operations for storing data in a file system according to some embodiments of the subject application. The flow chart 100 of FIG. 10 includes operations similar to or identical to those described above in accordance with FIGS. 3, 3A, 3B, 3C, 5, 5A, 5B, 5C, 6, 6A and 6B. The flow chart of FIG. 10 includes operations that may be performed by the apparatus as shown in FIG. 1, FIG. 2, FIG. 3, FIG. 3A, FIG. 3B, FIG. 3C, FIG. 4, FIG. 5, FIG. 5A, FIG. 5B, FIG. 5C, FIG. 6A, FIG. 6B and FIG. 7.

The operations 101, 102, 103, 104, 105, 106, 107 and 108 may be performed in sequence. The operations 101, 102, 103, 104, 105, 106, 107 and 108 may be performed in an order different than that shown in FIG. 10.

In operation 101, data associated with one or more client hosts are received by an apparatus through the help of a transceiving unit. The data may be received from a unique client host. The data may be received from multiple client hosts. The data may include attribute associated with a unique client host. The data may include attribute associated with a user account. The data may include attribute associated with a unique int net protocol (IP) address. The data may include attribute(s) other than the attributes as discussed above.

In operation 102, the data received are divided into data segments. The data received may be divided by, for example but is not limited to, data striping technique.

In operation 103, the data segments are categorized into one or more categories or groups. For example, referring to FIG. 3C, the group G1 includes data segments G1₁, G1₂ and G1₃; the group G2 includes data segments G2₁, G2₂ and G2₃; the group G3 includes data segments G3₁, G3₂ and G3₃; the group G4 includes data segments G4₁, G4₂ and G4₃, and the group G5 includes data segments G5₁, G5₂ and G5₃. In some embodiments, a group of data may include a number of M segments, wherein M is a positive integer.

In operation 104, the data segments are stored in a consecutive storage region of one or more storage units. Assuming that the data segments are stored in a number of N storage units and that each of the group (e.g., G1) include M segments (e.g., G1₁, G1₂, . . . G1_{M}), wherein M is a positive integer, N is a positive integer and N is greater than M.

The operation 104 includes storing first data segment (e.g., G1₁, G2₁, G3₁ . . . ) in the i^{th} storage unit. The operation 104 includes storing second data segment (e.g., G1₂, G2₂, G3₂ . . . ) in the (i+1)^{th} storage unit. The operation 104 includes storing third data segment (e.g., G1₃, G2₃, G3₃ . . . ) in the (i+2)^{th} storage unit, and so forth. The operation 104 includes storing the last data segment (e.g., G1_{M}, G2_{M}, G3_{M} . . . ) of a group in the (i+M−1)^{th} storage unit.

In operation 104, data segments of different groups may be stored in different storage units. For example, referring to FIG. 3C, each of the groups G1, G2, G3, G4 and G5 includes 3 segments. The data segments G1₁, G1₂ and G1₃ are stored in the storage units 16-1, 16-2 and 16-3. The data segments G2₁, G2₂ and G2₃ are stored in the storage units 16-4, 16-5 and 16-1. The data segments G3₁, G3₂ and G3₃ are stored in the storage units 16-2, 16-3 and 16-4. The data segments G4₁, G4₂ and G4₃ are stored in the storage units 16-5, 16-1 and 16-2. The data segments G5₁, G5₂ and G5₃ are stored in the storage units 16-3, 16-4 and 16-5.

In operation 104, data segments of different groups may be stored in the same storage units. For example, referring to FIG. 6B, each of the groups G1, G2, G3, G4, G5 and G6 includes 3 segments. The data segments G1₁, G1₂ and G1₃ are stored in the storage units 16-1, 16-2 and 16-3. The data segments G3₁, G3₂ and G3₃ are stored in the storage units 16-1, 16-2 and 16-3. The data segments G5₁, G5₂ and G5₃ are stored in the storage units 16-1, 16-2 and 16-3. The data segments G2₁, G2₂ and G2₃ are stored in the storage units 16-4, 16-5 and 16-6. The data segments G4₁, G4₂ and G4₃ are stored in the storage units 16-4, 16-5 and 16-6. The data segments G6₁, G6₂ and G6₃ are stored in the storage units 16-4, 16-5 and 16-6.

In operation 104, the data segments are stored in a consecutive storage region of the storage units. For example, referring to FIG. 3C, the data segments are stored in the consecutive storage regions 16-1A, 16-2A, 16-3A, 16-4A and 16-5A of the storage units 16-1, 16-2, 16-3, 16-4 and 16-5, respectively.

In operation 105, error correcting data associated with the data segments are generated and then stored in the storage units.

For example, referring to FIG. 3C, error correction data G1P associated with the data segments G1₁, G1₂ and G1₃ is generated by, for example, the control unit 2, and then stored in the storage unit 16-4. Error correction data G2P associated with the data segments G2₁, G2₂ and G2₃ is generated by, for example, the control unit 2, and then stored in the storage unit 16-2. Error correction data G3P associated with the data segments G3₁, G3₂ and G3₃ is generated by, for example, the control unit 2, and then stored in the storage unit 16-5. Error correction data G4P associated with the data segments G4₁, G4₂ and G4₃ is generated by, for example, the control unit 2, and then stored in the storage unit 16-3. Error correction data G5P associated with the data segments G5₁, G5₂ and G5₃ is generated by, for example, the control unit 2, and then stored in the storage unit 16-1.

In operation 105, the error correction data associated with one group is stored in a storage unit different from those for storing the data segments of the group. In some embodiments, a group of data (e.g., G1) includes M segments, the error correction data (e.g., G1P) associated with the group is stored in a storage unit (e.g., the (i+M)_{N}^{th} storage unit) next to or adjacent to the storage unit for storing the last data segment of the group (e.g., the (i+M−1)_{N}^{th} storage unit for storing the segment G1_{M}).

For example, referring to FIG. 3C, the error correction data G1P associated with the group G1 is stored in a storage unit different from those for storing data segments G1₁, G1₂, and G1₃. The error correction data G1P associated with the group G1 is stored in a storage unit next to that for storing the last data segment G1₃ of the group G1.

In operation 105, the error correction data are stored in a consecutive storage region of the storage units. For example, referring to FIG. 3C, the error correction data G1P, G2P, G3P, G4P and G5P are stored in the consecutive storage regions 16-1B, 16-2B, 16-3B, 16-4B and 16-5B of the storage units 16-1, 16-2, 16-3, 16-4 and 16-5, respectively.

In operation 106, a spare region is allocated for each group of data.

The spare region (e.g., G1S) associated with one group (e.g., G1) is allocated in a storage unit different from those for storing the data segments (e.g., G1₁, G1₂, . . . and G1_{M}) and the error correction data (e.g., G1P) of the group. In some embodiments, a group of data (e.g., G1) includes M segments, the spare region (e.g., G1S) associated with the group (e.g., G1) is allocated in a storage unit (e.g., the (i+M+1)_{N}^{th} storage unit) next to or adjacent to the storage unit for storing the error correction data of the group (e.g., the (i+M)_{N}^{th} storage unit for storing the error correction data G1P).

In operation 107, a determination is made, for example, by the control unit 2, on whether the flow chart 100 comes to an end. In the condition that the number of storage units (e.g., N) and the number of data segments (e.g., M) in each group of data are co-prime (mutual-prime), the flow chart 100 ends after the operation 107. In the condition that the number of storage units (e.g., N) and the number of data segments (e.g., M) in each group of data are not co-prime (mutual-prime), the flow chart 100 further includes an operation 108.

In operation 108, in the condition that the number of storage units (e.g., N) and the number of data segments (e.g., M) in each group of data are not co-prime (mutual-prime), the error correction data (e.g., G1P, G2P, . . . ) and the spare region (e.g., G1S, G2S, . . . ) for each of group is equally spread over the storage units.

For example, referring to FIG. 6B, the error corrections data G2P, G4P and G6P are equally spread over the storage units 16-1, 16-2 and 16-3. The spare regions G2S, G4S and G6S are equally spread over the storage units 16-2, 16-3 and 16-4. Similarly, the error corrections data G1P, G3P and G5P are equally spread over the storage units 16-4, 16-5 and 16-6. The spare regions G1S, G3S and G5S are equally spread over the storage units 16-5, 16-6 and 16-1.

In the condition that the number of storage units (e.g., N) and the number of data segments (e.g., M) in each group of data are not co-prime (mutual-prime), two different groups of data may be stored in the same storage units. Assuming that a group G1 including M segments are stored in the i^{th} storage unit to the (i+M−1)_{N}^{th} storage unit and that a group G2 including M segments are also stored in the i^{th} storage unit to the (i+M−1)ₙ^{th} storage unit. The operation 108 includes storing the error correction data associated with the group G1 in a storage unit different from the i^{th} to (i+M−1)_{N}^{th} storage units, and then storing the error correction data associated with the group G2 in a storage unit different from the i^{th}to (i+M−1)_{N}^{th} storage units and also different from that for storing the error correction data. associated with the group G1.

In general, the operation 108 includes storing a group G1 including M segments in the i^{th} storage unit to the (i+M−1)_{N}^{th} storage unit and storing a group G2 including M segments also in the i^{th} storage unit to the (i+M−1)_{N}^{th} storage unit. The operation 108 includes storing error correction data associated with the group G1 in a (i+M−1+k₁)_{N}^{th} storage unit and storing error correction data associated with the group G2 in a (i+M−1+k₂)_{N}^{th} storage unit. Wherein (i+M−1)_{N} is defined as (i+M−1) mod N. Wherein (i+M−1+k₁)_{N} is not in the range from i to (i+M−1)_{N}. That is, (i+M−1+k₁)_{N} ∉ {(i+x)_{N}|x=0,1,2 . . . ,M−1}. Wherein (i+M−1+k₂)_{N} is not in the range from i to (i+M−1)_{N}. That is, (i+M−1+k₂)_{N} ∉ {(i+x)_{N}|x=0,1,2 . . . ,M−1}. Wherein M, N, k₁ and k₂ are positive integers, k₁≠k₂ and N is greater than M.

In some embodiments, the operation 104 includes storing an i^{th} group of data including M segments in M storage units, starting from a Dᵢ^{th} storage unit to a (Dᵢ+M−1)_{N}^{th} storage unit. The symbol Dᵢ^{th} indicates a storage unit for storing the first segment of the i^{th} group of data.

The first segment of the i^{th} group of data is stored in a consecutive storage region of the Dᵢ^{th} storage unit. The second segment of the i^{th} group of data is stored in a consecutive storage region of the (Dᵢ+1)_{N}^{th} storage unit. The third segment of the i^{th} group of data is stored in a consecutive storage region of the (Dᵢ+2)_{N}^{th} storage unit, and so forth. The last segment of the i^{th} group of data is stored in a consecutive storage region of the (Dᵢ+M−1)_{N}^{th} storage unit.

In some embodiments, the operation 105 includes storing an error correction data associated with the i^{th} group of data in a consecutive storage region of a (Dᵢ+M−1+pᵢ)_{N}^{th} storage unit. The collection of Dᵢ and pᵢ are configured so that all the data groups including M segments are allocated evenly across the storage units. The collection of Dᵢ and pᵢ are configured so that the error correction data associated with all the data groups are allocated evenly across the storage units.

The storage unit on which the error correction data associated with the i^{th} group of data is stored complies with the following equation:

(Dᵢ+M−1+pᵢ)_{N} ∉ {(Dᵢ+x)_{N}|x=0,1,2, . . . ,M−1} (1)

The symbols i, Dᵢ, M, N and pᵢ are positive integers.

In some embodiments, the operation 105 includes storing an additional error correction data associated with the i^{th} group of data in a consecutive storage region of a (Dᵢ+M−1+qᵢ)_{N}^{th} storage unit. The collection of Dᵢ, pᵢ and qᵢ are configured so that the error correction data associated with all the data groups are allocated evenly across the storage units. The storage unit on which the additional error correction data associated with the i^{th} group of data is stored complies with the following equation:

(Dᵢ+M−1+qᵢ)_{N} ∉ {(Dᵢ+x)_{N}|x=0,1,2 . . . ,M−1} (2)

The symbols i, Dᵢ, M, N, pᵢ and qᵢ are positive integers and pᵢ≠qᵢ.

In some embodiments, the operation 106 includes reserving a storage region associated with the i^{th} group of data in a consecutive storage region of a (Dᵢ+M−1+sᵢ)_{N}^{th} storage unit for data reconstruction. The collection of Dᵢ, pᵢ, qᵢ and sᵢ are configured so that all the storage regions reserved for the data reconstruction process are allocated evenly across the storage units. The storage unit on which the storage region is reserved for the i^{th} group of data is specified in accordance with the following equation:

(Dᵢ+M−1+sᵢ)_{N} ∉ {(Dᵢ+x)_{N}|x=0,1,2 . . . M−1} (3)

The symbols i, Dᵢ, M, N and sᵢ are positive integers and pᵢ≠qᵢ≠sᵢ.

As used herein, the singular terms “a,” “an,” and “the” may include plural referents unless the context clearly dictates otherwise. In the description of some embodiments, a component provided “on,” “above,” or “over” another component can encompass cases where the former component is directly on (e.g., in physical contact with) the latter component, as well as cases where one or more intervening components are located between the former component and the latter component.

As used herein, the terms “substantially,” “approximately,” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, the term “about” or “substantially” equal in reference to two values can refer to a ratio of the two values being within a range between and inclusive of 0.9 and 1.1

Additionally, amounts, ratios, and other numerical values are sometimes presented herein in a range format. It is to be understood that such a range format is used for convenience and brevity and should be understood flexibly to include numerical values explicitly specified as limits of a range, but also to include all individual numerical values or sub-ranges encompassed within that range as if each numerical value and sub-range is explicitly specified.

While the subject application has been described and illustrated with reference to specific embodiments thereof, these descriptions and illustrations do not limit the subject application. It should be understood by those skilled in the art that various changes may be made and equivalents may be substituted without departing from the true spirit and scope of the subject application, as defined by the appended claims. The illustrations may not be necessarily drawn to scale. There may be other embodiments of the subject application which are not specifically illustrated. The specification and drawings are to be regarded as illustrative rather than restrictive. Modifications may be made to adapt a particular situation, material, composition of matter, method, or process to the objective, spirit and scope of the subject application. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the subject application. Accordingly, unless specifically indicated herein, the order and grouping of the operations are not limitations of the subject application.

What is claimed is:

1. An apparatus, comprising:
a control unit;
a memory including computer program code;
a first storage unit electrically connected to the control u rage unit having a first consecutive storage region and a second consecutive storage region;
a transceiving unit electrically connected to the control unit, the transceiving unit receiving a number M of categories of first data having a first attribute, where M is a positive integer;
wherein the memory and the computer program code are configured to, with the control unit, cause the apparatus to perform:
storing the number M of categories of first data in the first consecutive storage region of the first storage unit; and
storing number N of first error correction data in the second consecutive storage region of the first storage unit, where N is a positive integer, and wherein the number N of first correction data stored in the second consecutive storage region of the first storage unit are independent of the number M of categories of first data stored in the first consecutive storage region of the first storage unit.

2. The apparatus of claim 1, further comprising a second storage unit electrically connected to the control unit, the second storage unit having a first consecutive storage region and a second consecutive storage region, wherein the transceiving unit receives a number O of categories of second data having a second attribute, where O is a positive integer; and wherein the memory and the computer program code are configured to, with the control unit, cause the apparatus to perform:
storing the number O of categories of second data in the first consecutive storage region of the second storage unit; and
storing a number P of second error correction data in the second consecutive storage region of the second storage unit, where P is a positive integer; and wherein the number P of second error correction data are independent of the number O of categories of second data stored in the first consecutive storage region of the second storage unit.

3. The apparatus of claim 2, further comprising a third storage unit electrically connected to the control unit, the third storage unit having a first consecutive storage region and a second consecutive storage region, wherein the transceiving unit receives a number Q of categories of third data having a third attribute, where Q is a positive integer; and wherein the memory and the computer program code are configured to, with the control unit, cause the apparatus to perform:
storing the number Q of categories of third data in the first consecutive storage region of the third storage unit; and
storing a number R of third error correction data in the second consecutive storage region of the third storage unit, where R is a positive integer, and wherein the number R of third error correction data stored in the second consecutive storage region of the third storage unit are independent of the number Q of categories of third data stored in the first consecutive storage region of the third storage unit.

4. The apparatus of claim 2, wherein one of the number P of second error correction data stored in the second consecutive storage region of the second storage unit is associated with one of the number M of categories of first data stored in the first consecutive storage region of the first storage unit.

5. The apparatus of claim 3, wherein the number P of second error correction data stored in the second consecutive storage region of the second storage unit are independent of the number M of categories of first data stored in the first consecutive storage region of the first storage unit.

6. The apparatus of claim 5, wherein one of the number R of third error correction data stored in the second consecutive storage region of the third storage unit is associated with one of the number M of categories of first data stored in the first consecutive storage region of the first storage unit.

7. The apparatus of claim 3, wherein at least one of the number P of second error correction data or the number R of third error correction data is associated with one of the number M of categories of first data stored in the first consecutive storage region of the first storage unit.

8. The apparatus of claim 3, wherein the third storage unit further comprises a third consecutive storage region, wherein the memory and the computer program code are configured to, with the control unit, cause the apparatus to store a number S of fourth error correction data in the third consecutive storage region of the third storage unit, and wherein one of the number S of fourth error correction data patterns stored in the third consecutive storage region of the third storage unit is associated with one of the number M of categories of first data stored in the first consecutive storage region of the first storage unit.

9. The apparatus of claim 3, wherein the third storage unit further comprises a third consecutive storage region, and wherein the memory and the computer program code are configured to, with the control unit, cause the apparatus to store one of the M categories of first data rebuilt in accordance with one of the number P of the second error correction data in the third consecutive storage region of the third storage unit.

10. The apparatus of claim 1, wherein the first consecutive storage region comprises a series of physically consecutive addresses and the second consecutive storage region comprises a series of physically consecutive addresses.

11. The apparatus of claim 10, wherein one of the series of physically consecutive addresses of the first consecutive storage region is next to one of the series of physically consecutive addresses of the second consecutive storage region.

12. The apparatus of claim 1, wherein the first consecutive storage region comprises a series of logically consecutive addresses and the second consecutive storage region comprises a series of logically consecutive addresses.

13. The apparatus of claim 12, wherein one of the series of logically consecutive addresses of the first consecutive storage region is next to one of the series of logically consecutive addresses of the second consecutive storage region.

14. A storage system, comprising:
a first storage unit having a first consecutive storage region and a second consecutive storage region;
the first storage unit stores a number M of categories of first data received having a first attribute in the first consecutive storage region, where M is a positive integer;
the first storage unit stores a number N of first error correction data in the second consecutive storage region, where N is a positive integer;
wherein the number N of first error correction data stored in the second consecutive storage region of the first storage unit are independent of the number M of categories of first data stored in the first consecutive storage region of the first storage unit.

15. The storage system of claim 14, further comprising a second storage unit having a first consecutive storage region and a second consecutive storage region;
the second storage unit stores a number O of categories of second data having a second attribute in the first consecutive storage region, where O is a positive integer;
the second storage unit stores a number P of second error correction data in the second consecutive storage region, where P is a positive integer;
wherein the number P of second error correction data stored in the second consecutive storage region of the second storage unit are independent of the number O of categories of second data stored in the first consecutive storage region of the second storage unit.

16. The storage system of claim 15, further comprising a third storage unit having a first consecutive storage region and a second consecutive storage region;
the third storage unit stores a number Q of categories of third data having a third attribute in the first consecutive storage region, where Q is a positive integer;
the third storage unit stores a number R of third error correction data in the second consecutive storage region, where R is a positive integer;
wherein the number R of third error correction data stored in the second consecutive storage region of the third storage unit are independent of the number Q of categories of third data stored in the first consecutive storage region of the third storage unit.

17. The storage system of claim 15, wherein one of the number P of second error correction data stored in the second consecutive storage region of the second storage unit is associated with one of the number M of categories of first data stored in the first consecutive storage region of the first storage unit.

18. The storage system of claim 16, wherein the number P of second error correction data stored in the second consecutive storage region of the second storage unit are independent of the number M of categories of first data stored in the first consecutive storage region of the first storage unit.

19. The storage system of claim 18, wherein one of the number R of third error correction data stored in the second consecutive storage region of the third storage unit is associated with one of the number M of categories of first data stored in the first consecutive storage region of the first storage unit.

20. A method for storing data in a storage system having N storage units, each of the N storage units having a first consecutive storage region and a second consecutive storage region, the method comprising:
storing a group of first data including M segments in the first consecutive storage region of a i^{th} storage unit to a (i+M−1)_{N}^{th} storage unit;
storing a first error correction data associated with the group of first data in the second consecutive storage region of a (i+M−1+k₁)_{N}^{th} storage unit;
storing a group of second data including M segments in the first consecutive storage region of the i^{th} storage unit to the (i+M−1)_{N}^{th} storage unit; and
storing a second error correction data associated with the group of second data in the second consecutive storage region of a (i+M−1+k₂)_{N}^{th} storage unit; wherein
(i+M+1)_{N} is defined as (i+M−1) mod N;
(i+M−1+k₁)_{N} ∉ {(i+x)_{N}|x=0,1,2 . . . , M−1};
(i+M−1+k₂)_{N} ∉ {(+x)_{N}|x=0,1,2, . . . ,M−1};
M, N, k₁ and k₂ are positive integers;
N is greater than M;
k₁≠k₂; and
N and M are not co-prime to each other.
